(19) United States
(12) Patent Application Publication
(10) Pub. No.: US 2025/0377732 A1
(43) Pub. Date: Dec. 11, 2025

(54) METHOD AND SYSTEMS FOR PERFORMING OPERATIONS IN RESPONSE TO MOTION INPUTS

(71) Applicant: Apple Inc., Cupertino, CA (US)

(72) Inventors: Taylor G. CARRIGAN, San Francisco, CA (US); Zara LALJI, Mountain View, CA (US); Hugo D. VERWEIJ, Portola Valley, CA (US); Charles C. HOYT, Pacifica, CA (US); Mitchell R. LERNER, San Francisco, CA (US); James N. JONES, San Francisco, CA (US); Jessica J. TRAN, Renton, WA (US)

(21) Appl. No.: 19/231,375

(22) Filed: Jun. 6, 2025

Related U.S. Application Data
(60) Provisional application No. 63/657,820, filed on Jun. 8, 2024.

(51) Int. Cl. G06F 3/01; G06F 3/044; G06F 3/04842; G06F 3/0488; G06F 3/16

(52) U.S. Cl. CPC G06F 3/017; G06F 3/012; G06F 3/04842; G06F 3/0488; G06F 3/167; G06F 3/044

(57) ABSTRACT

The present disclosure generally relates to performing operations in response to motion inputs.

### CROSS-REFERENCE TO RELATED APPLICATIONS

This application claims priority to U.S. Patent Application No. 63/657,820, entitled “METHOD AND SYSTEMS FOR PERFORMING OPERATIONS IN RESPONSE TO MOTION INPUTS,” filed on Jun. 8, 2024, the content of which are hereby incorporated by reference in their entirety.

### FIELD

The present disclosure relates generally to performing operations in response to motion inputs, including to techniques for interacting with audio output events via motion inputs.

### BACKGROUND

Electronic devices can provide audio data via wireless connections to audio output devices such as wireless speakers and wireless headphones. Example audio output devices can interact with audio data using various input techniques.

### BRIEF SUMMARY

Some techniques for performing operations in response to motion inputs, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for performing operations in response to motion inputs. Such methods and interfaces optionally complement or replace other methods for performing operations in response to motion inputs. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method comprises: at a computer system that is in communication with one or more input devices: receiving, via the one or more input devices, an indication of a detection of a motion input; and in response to receiving the indication of the detection of the motion input: in accordance with a determination that the motion input includes a first type of recognized head gesture and the computer system has a first configuration, causing performance of a first operation; in accordance with a determination that the motion input includes the first type of recognized head gesture and the computer system has a second configuration that is different from the first configuration, forgoing causing performance of the first operation; and in accordance with a determination that the motion input includes a second type of recognized head gesture that is different from the first type of recognized head gesture and the computer system has the second configuration, causing performance of the first operation.

In accordance with some embodiments, a non-transitory computer-readable storage medium storing one or more programs configured to be executed by one or more processors of a computer system that is in communication with one or more input devices is described. The one or more programs include instructions for: receiving, via the one or more input devices, an indication of a detection of a motion input; and in response to receiving the indication of the detection of the motion input: in accordance with a determination that the motion input includes a first type of recognized head gesture and the computer system has a first configuration, causing performance of a first operation; in accordance with a determination that the motion input includes the first type of recognized head gesture and the computer system has a second configuration that is different from the first configuration, forgoing causing performance of the first operation; and in accordance with a determination that the motion input includes a second type of recognized head gesture that is different from the first type of recognized head gesture and the computer system has the second configuration, causing performance of the first operation.

In accordance with some embodiments, a transitory computer-readable storage medium storing one or more programs configured to be executed by one or more processors of a computer system that is in communication with one or more input devices is described. The one or more programs include instructions for: receiving, via the one or more input devices, an indication of a detection of a motion input; and in response to receiving the indication of the detection of the motion input: in accordance with a determination that the motion input includes a first type of recognized head gesture and the computer system has a first configuration, causing performance of a first operation; in accordance with a determination that the motion input includes the first type of recognized head gesture and the computer system has a second configuration that is different from the first configuration, forgoing causing performance of the first operation; and in accordance with a determination that the motion input includes a second type of recognized head gesture that is different from the first type of recognized head gesture and the computer system has the second configuration, causing performance of the first operation.

In accordance with some embodiments, a computer system configured to communicate with one or more input devices is described. The computer system comprises one or more processors and memory storing one or more programs configured to be executed by the one or more processors. The one or more programs include instructions for: receiving, via the one or more input devices, an indication of a detection of a motion input; and in response to receiving the indication of the detection of the motion input: in accordance with a determination that the motion input includes a first type of recognized head gesture and the computer system has a first configuration, causing performance of a first operation; in accordance with a determination that the motion input includes the first type of recognized head gesture and the computer system has a second configuration that is different from the first configuration, forgoing causing performance of the first operation; and in accordance with a determination that the motion input includes a second type of recognized head gesture that is different from the first type of recognized head gesture and the computer system has the second configuration, causing performance of the first operation.

In accordance with some embodiments, a computer system configured to communicate with one or more input devices is described. The computer system comprises: means for receiving, via the one or more input devices, an indication of a detection of a motion input; and means for, in response to receiving the indication of the detection of the motion input: in accordance with a determination that the motion input includes a first type of recognized head gesture and the computer system has a first configuration, causing performance of a first operation; in accordance with a determination that the motion input includes the first type of recognized head gesture and the computer system has a second configuration that is different from the first configuration, forgoing causing performance of the first operation; and in accordance with a determination that the motion input includes a second type of recognized head gesture that is different from the first type of recognized head gesture and the computer system has the second configuration, causing performance of the first operation.

In accordance with some embodiments, a computer program product is described. The computer program product comprises one or more programs configured to be executed by one or more processors of a computer system that is in communication with one or more input devices. The one or more programs include instructions for: receiving, via the one or more input devices, an indication of a detection of a motion input; and in response to receiving the indication of the detection of the motion input: in accordance with a determination that the motion input includes a first type of recognized head gesture and the computer system has a first configuration, causing performance of a first operation; in accordance with a determination that the motion input includes the first type of recognized head gesture and the computer system has a second configuration that is different from the first configuration, forgoing causing performance of the first operation; and in accordance with a determination that the motion input includes a second type of recognized head gesture that is different from the first type of recognized head gesture and the computer system has the second configuration, causing performance of the first operation.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for performing operations in response to motion inputs, thereby increasing the effectiveness, efficiency, and user satisfaction with such devices. Such methods and interfaces may complement or replace other methods for performing operations in response to motion inputs.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6AC2 illustrate examples of user interfaces for performing operations in response to motion inputs in accordance with some embodiments.

FIG. 7 is a block diagram of a method for performing operations in response to motion inputs in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for performing operations in response to motion inputs. For example, a first operation is performed in response to detection of a motion input in accordance with a determination that the motion input includes a first type of recognized head gesture and a device has a first configuration or in accordance with a determination that the motion input includes a second type of recognized head gesture and the device has a second configuration. In some embodiments, the first operation is not performed in response to the motion input in accordance with a determination that the motion input includes the first type of recognized head gesture and the device has the second configuration. In some embodiments, a second operation is performed in response to the motion input in accordance with a determination that the motion input includes the second type of recognized head gesture and the device has the first configuration or in accordance with a determination that the motion input includes the first type of recognized head gesture and the device has the second configuration. Such techniques can reduce the cognitive burden on a user who performs operations in response to motion inputs, thereby enhancing productivity. Further, such techniques can reduce processor and battery power otherwise wasted on redundant user inputs.

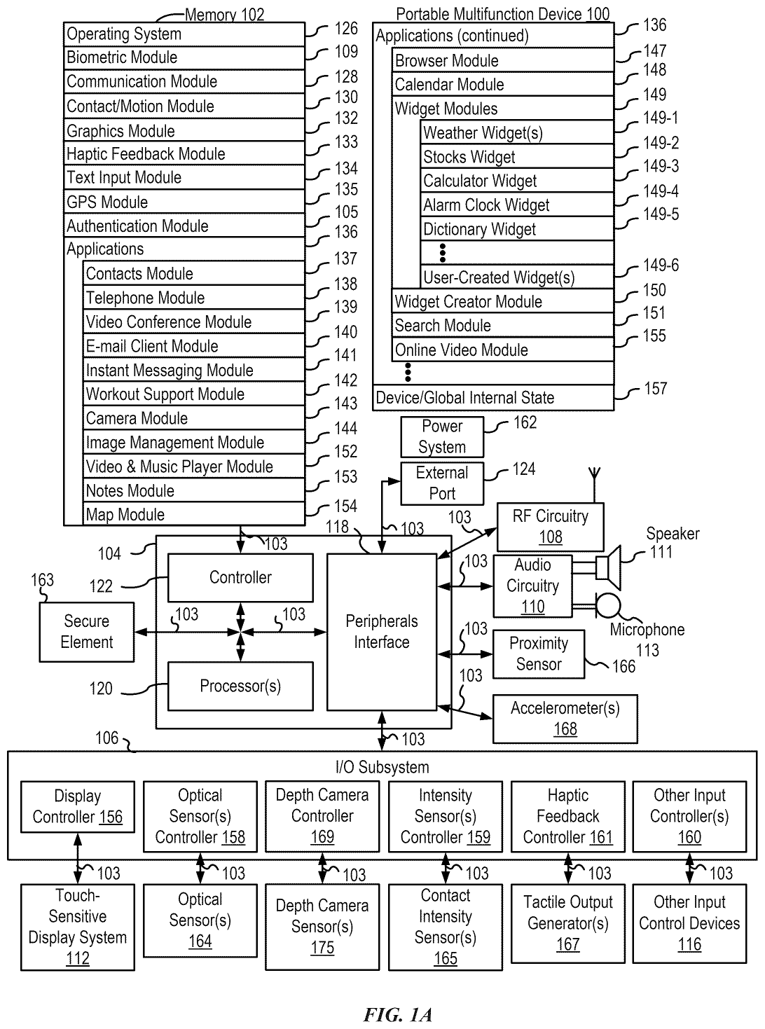

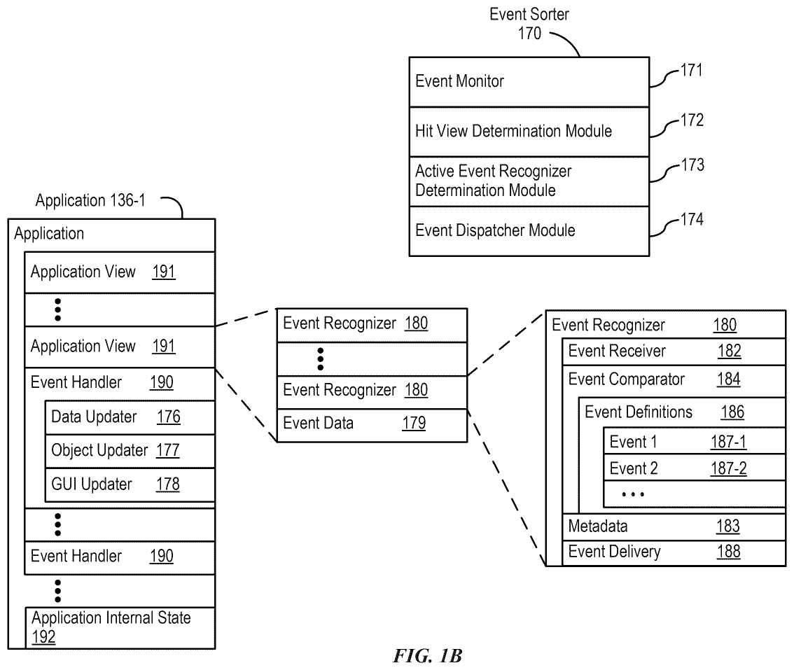

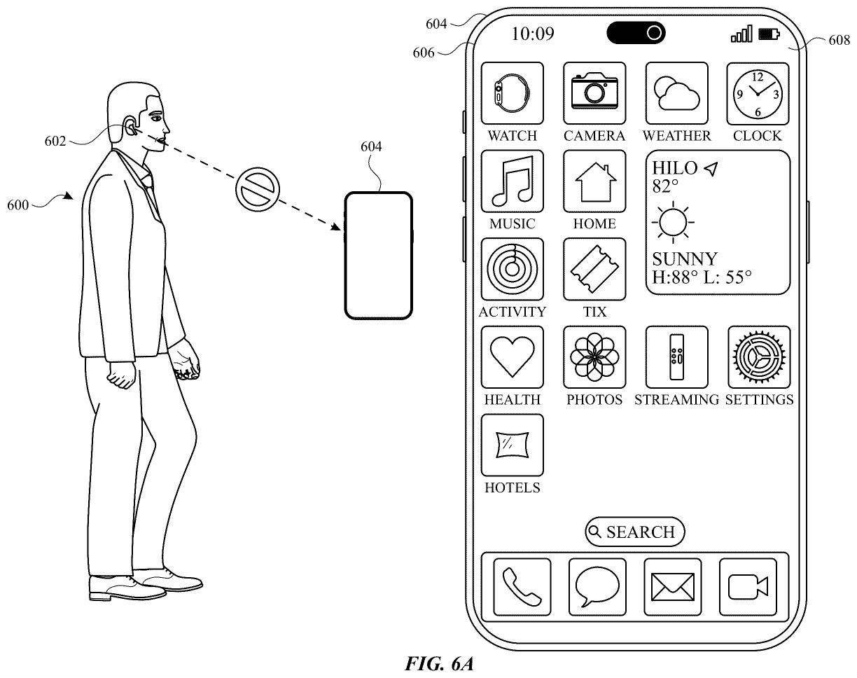

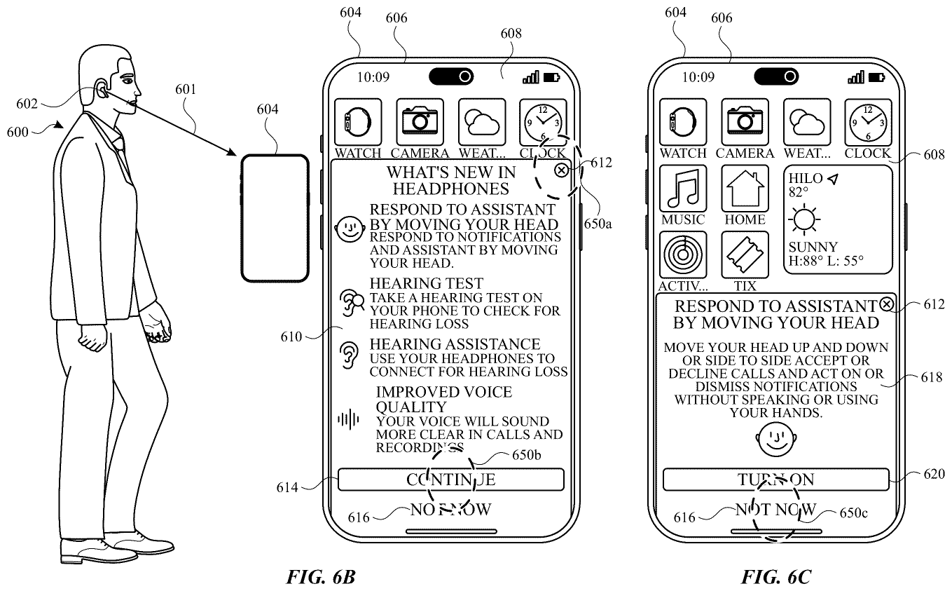

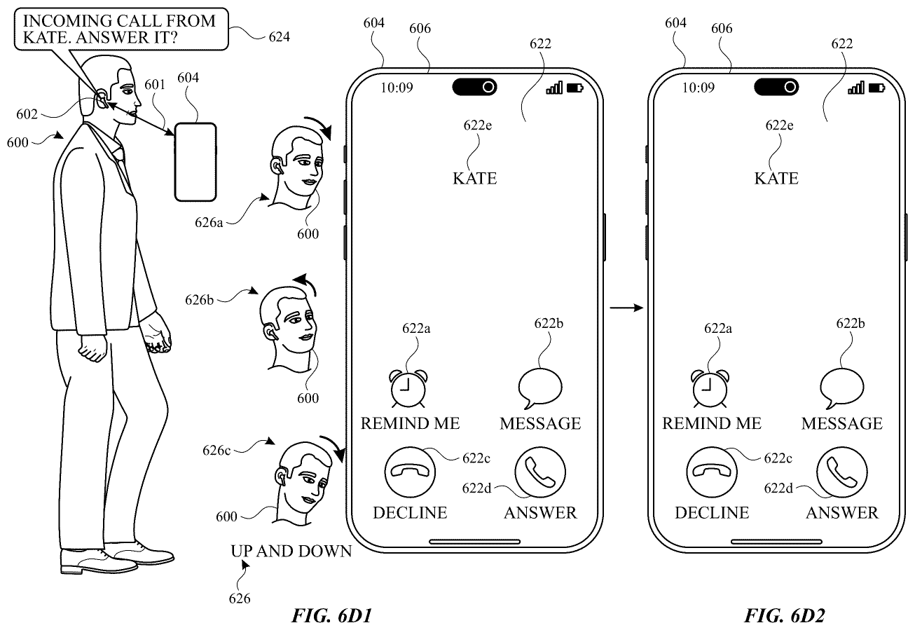

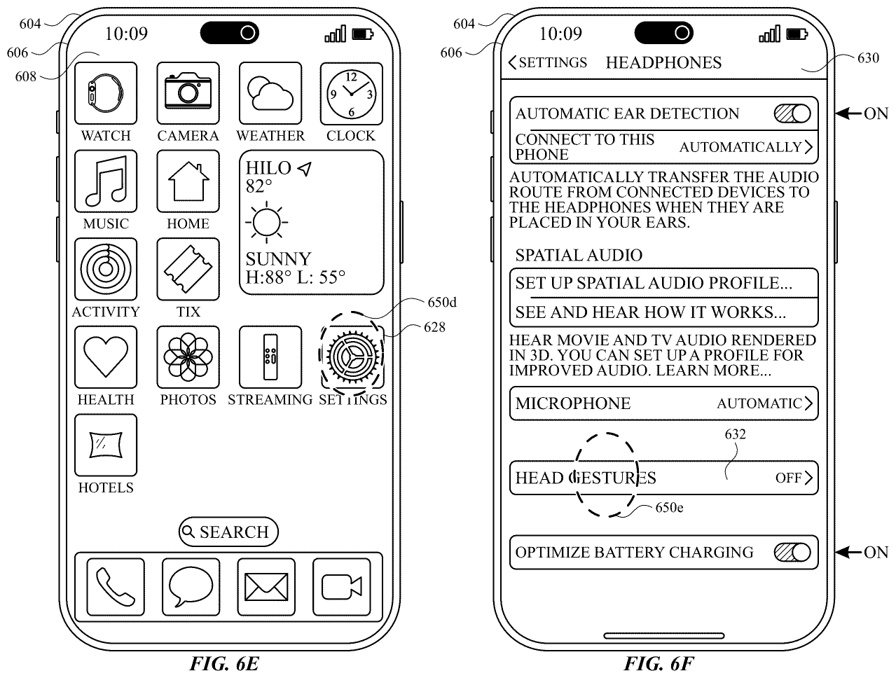

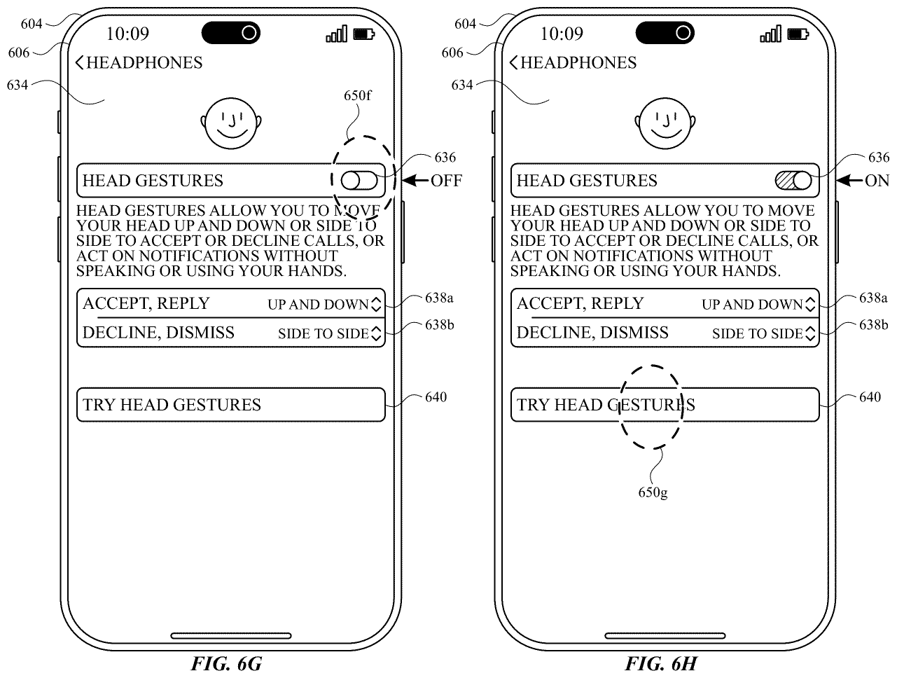

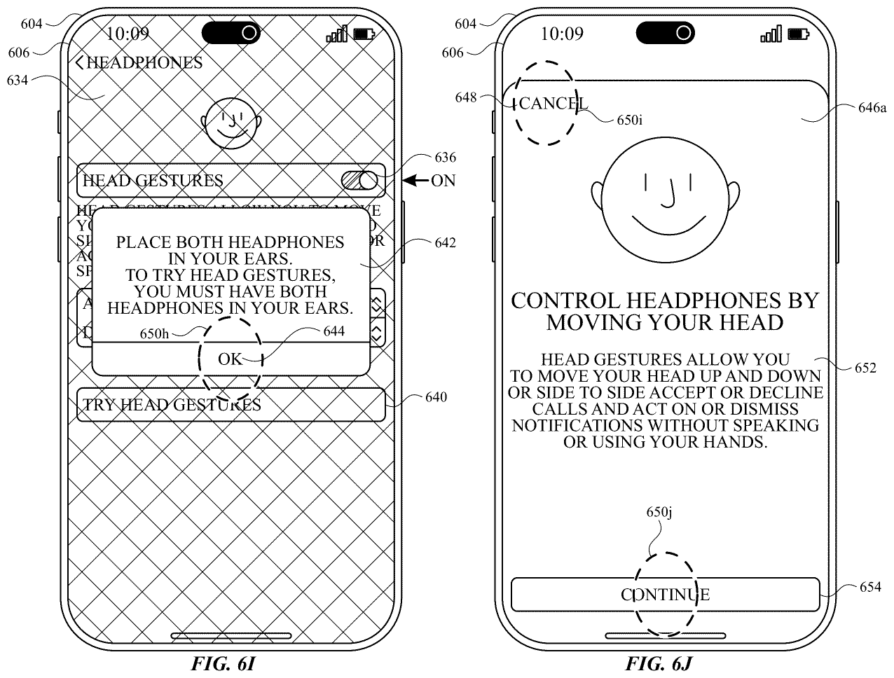

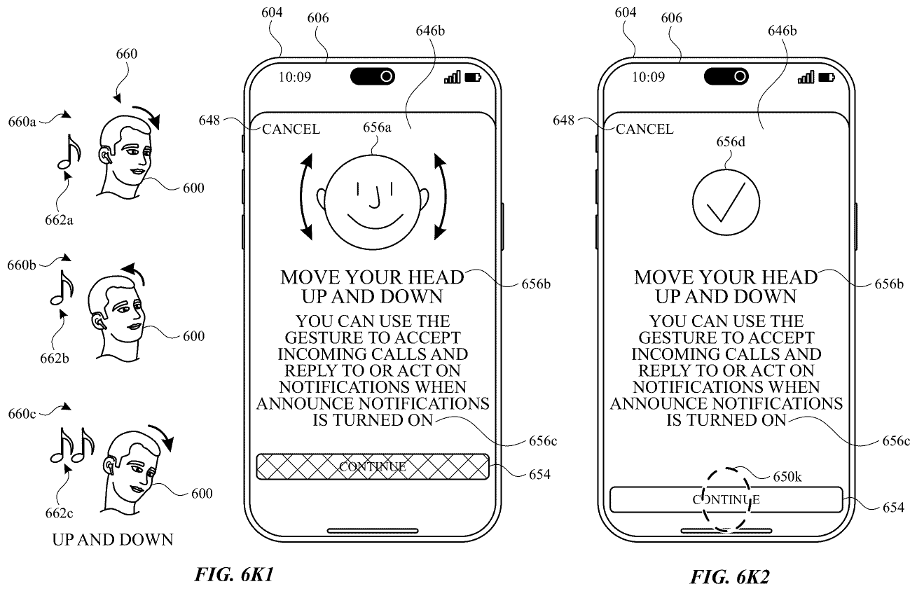

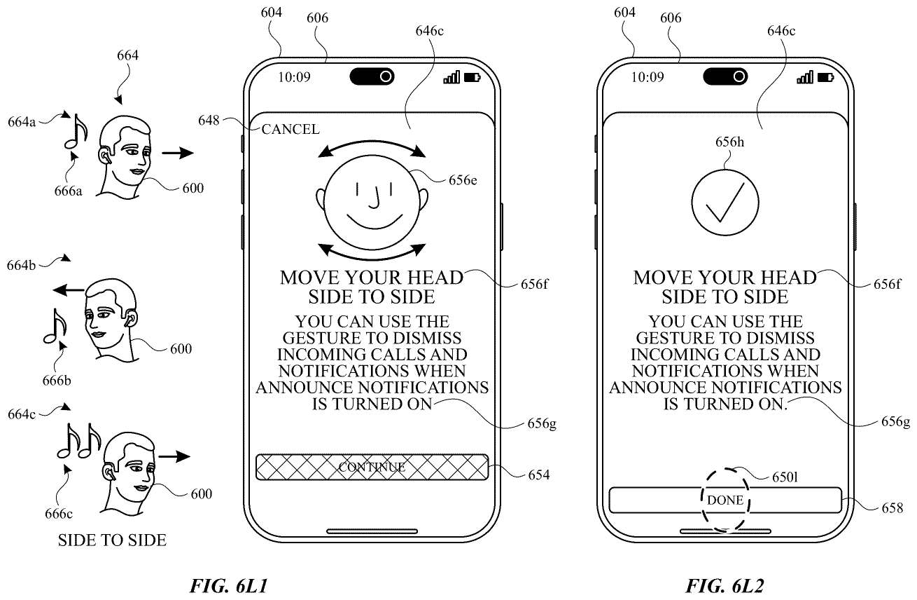

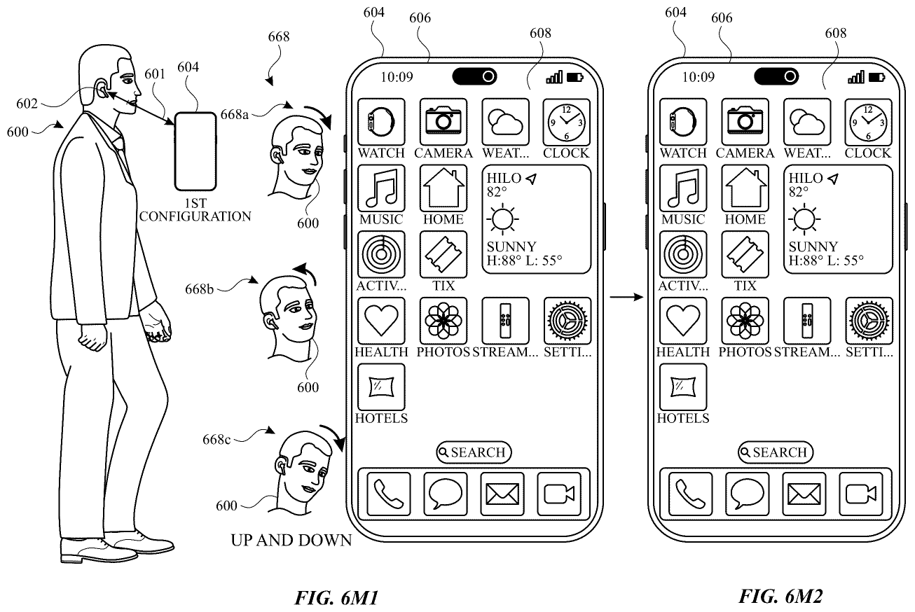

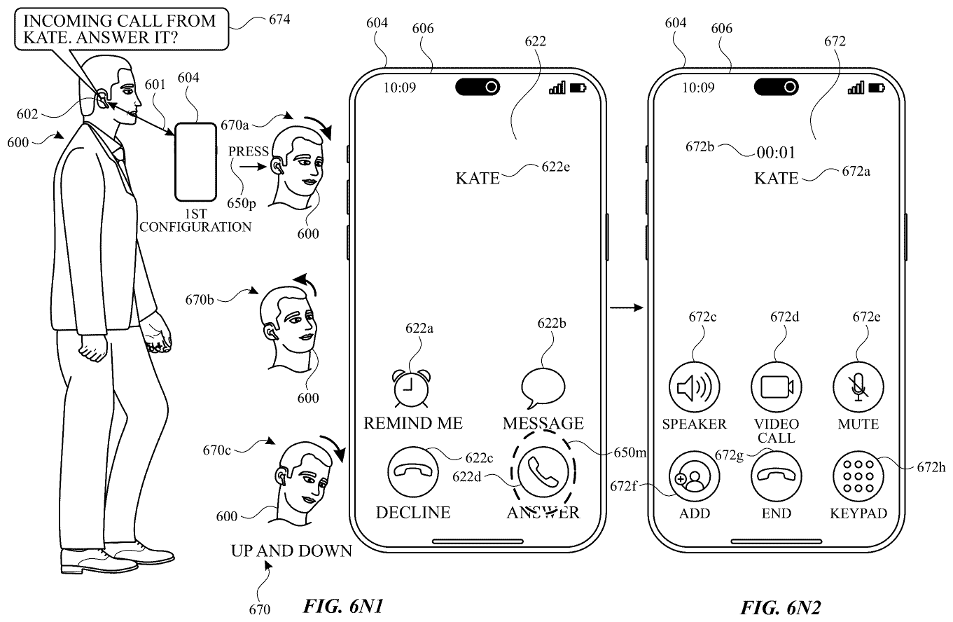

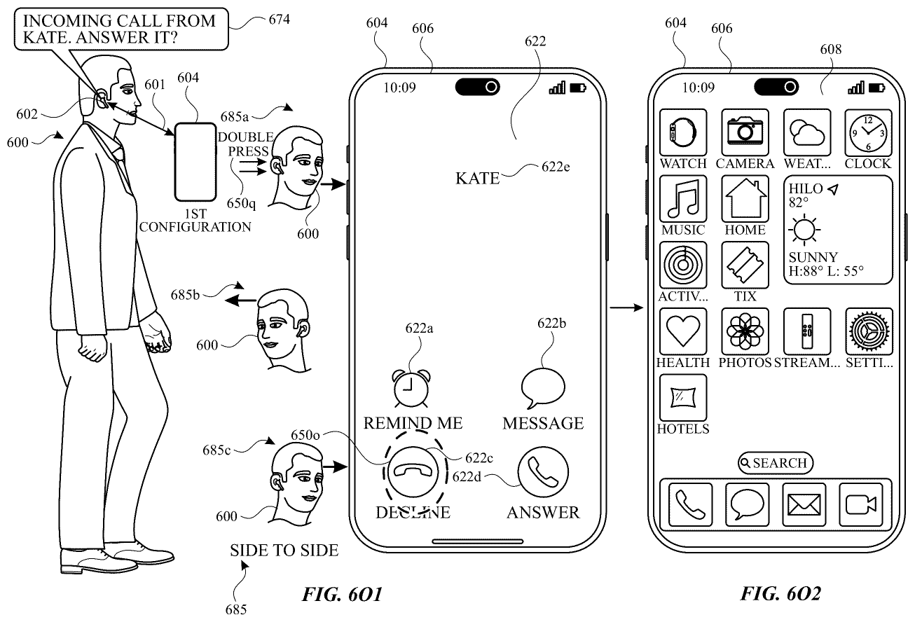

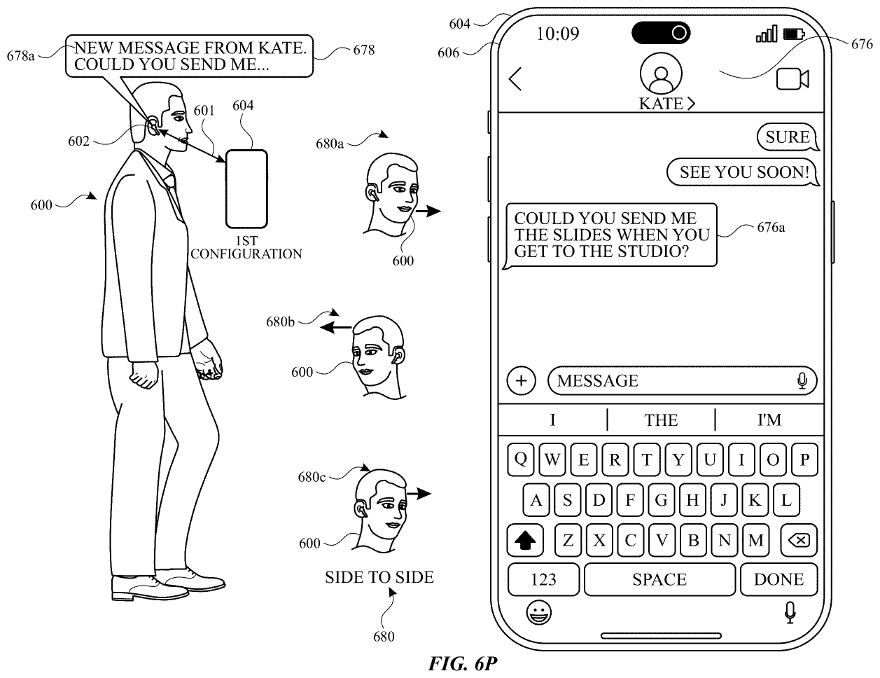

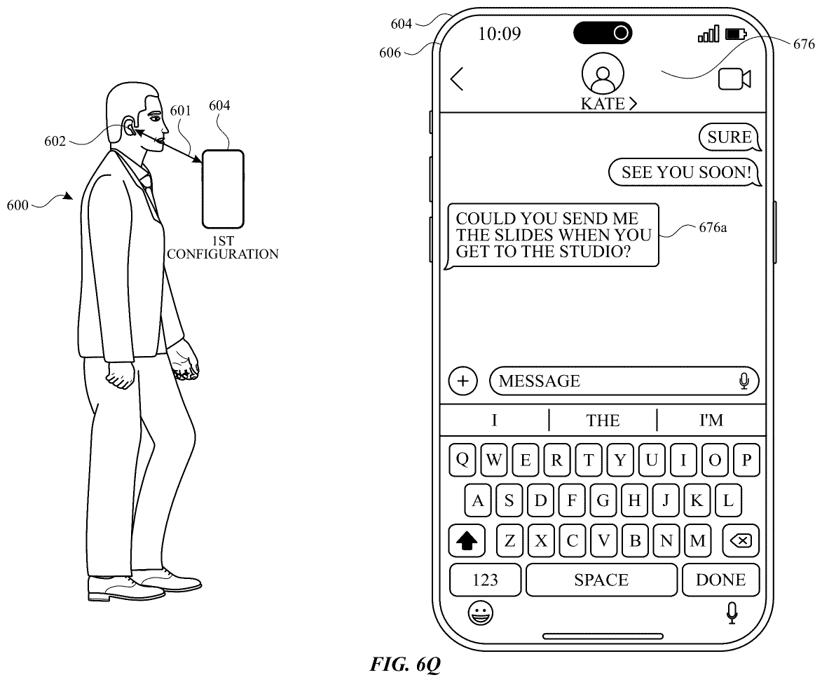

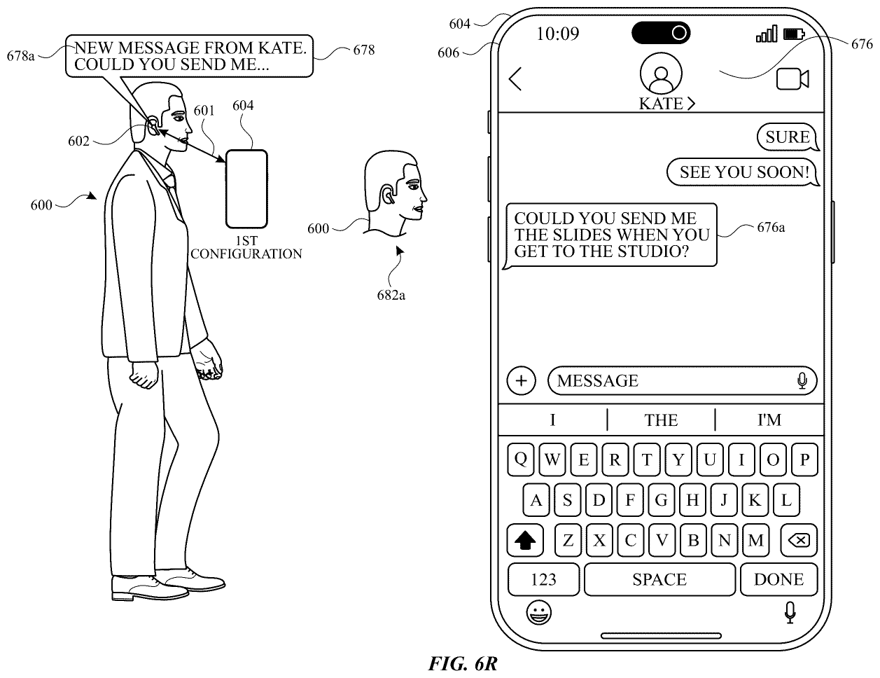

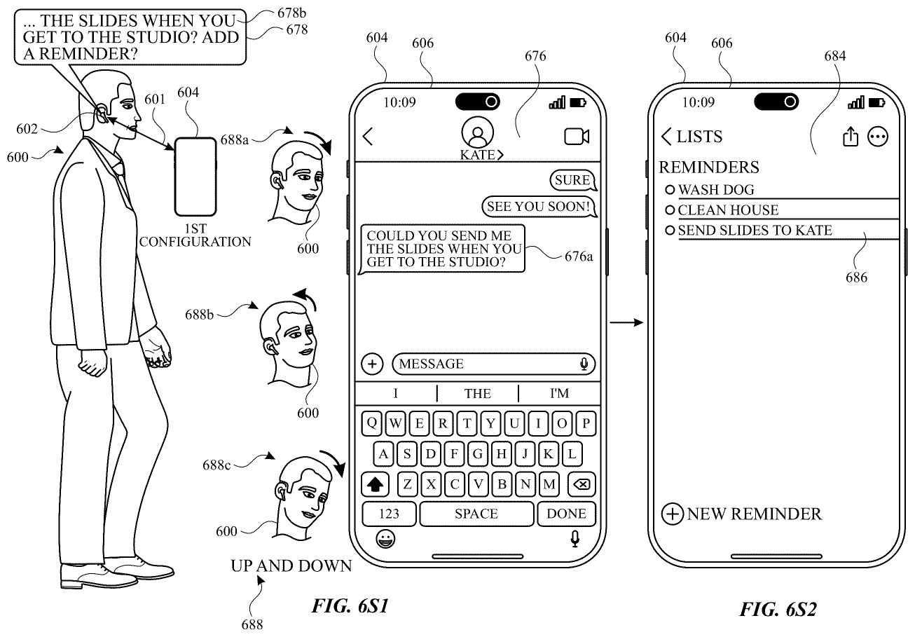

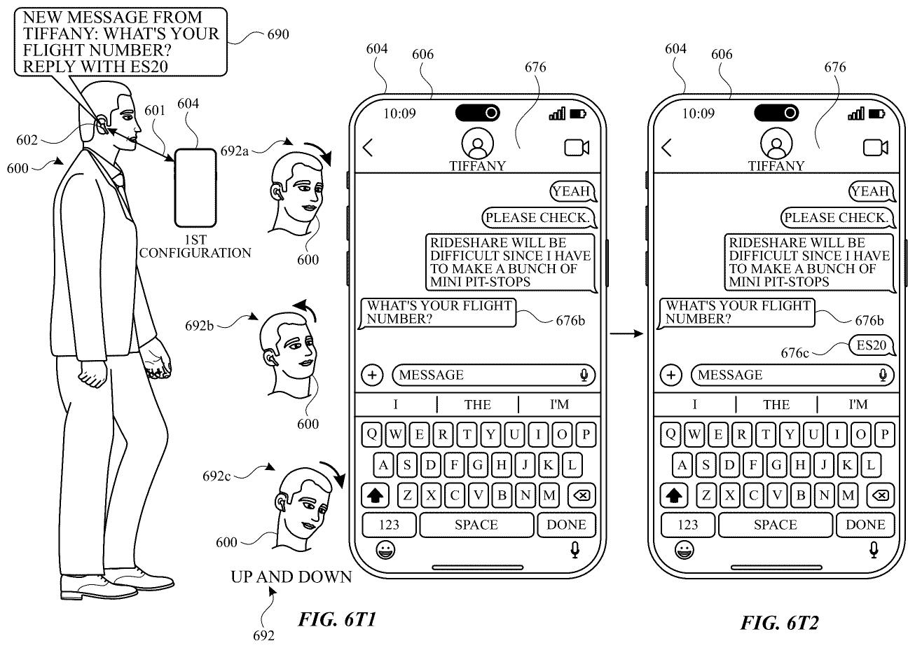

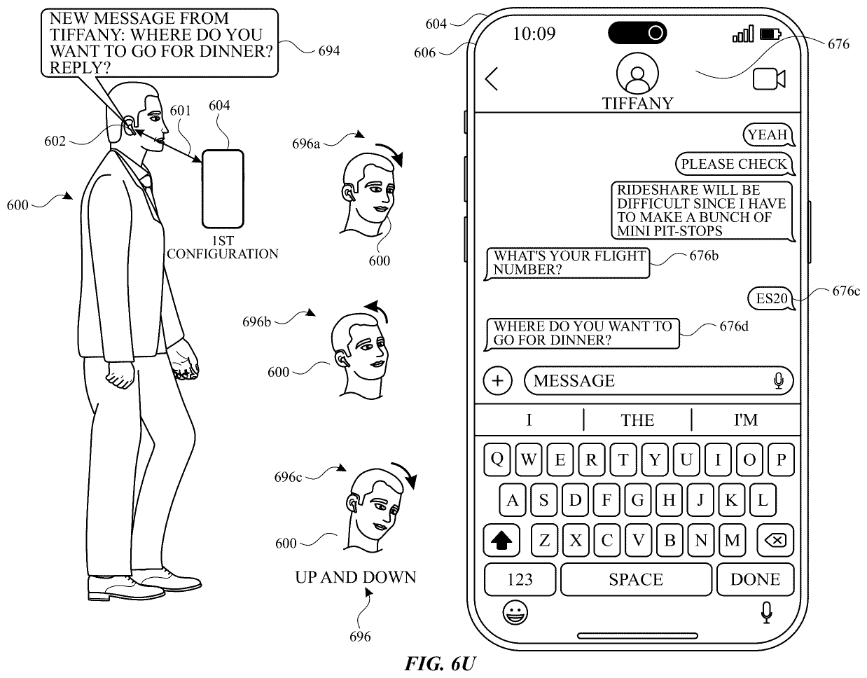

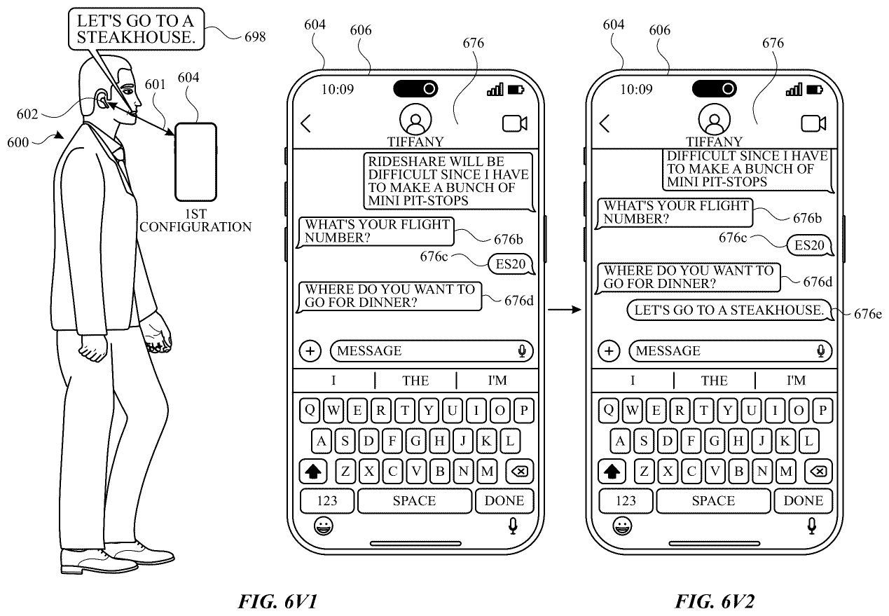

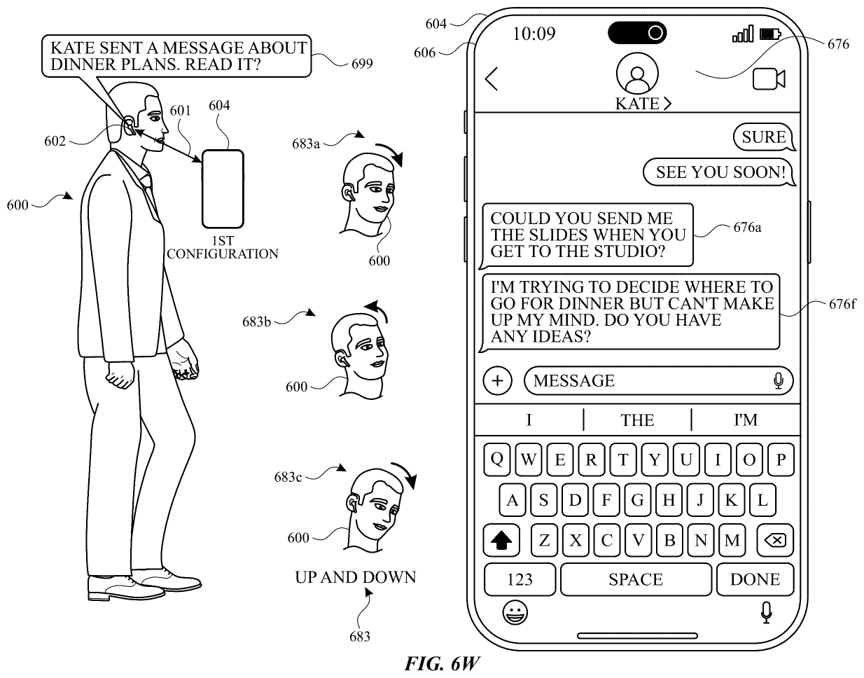

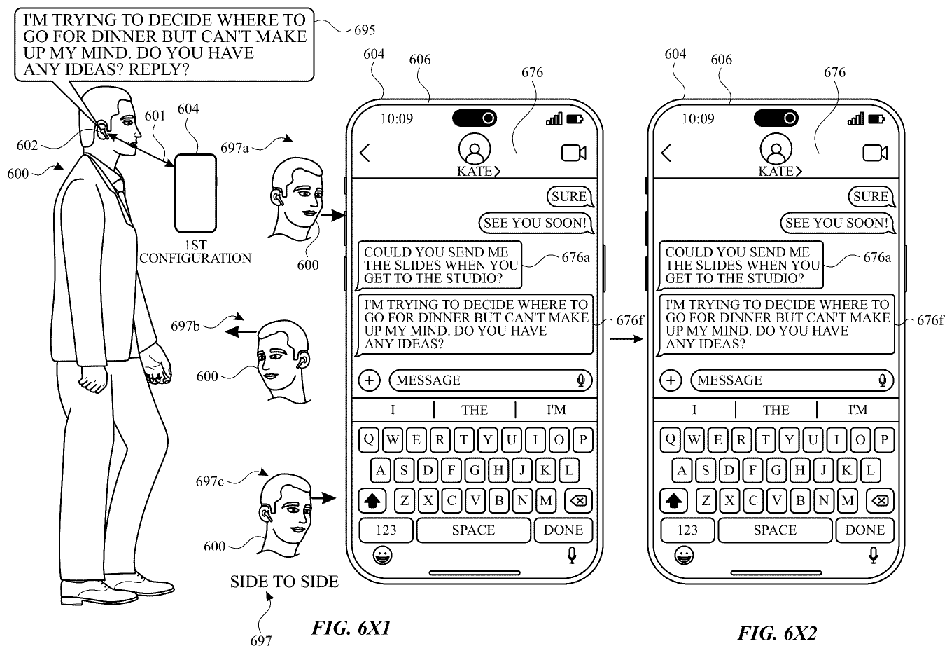

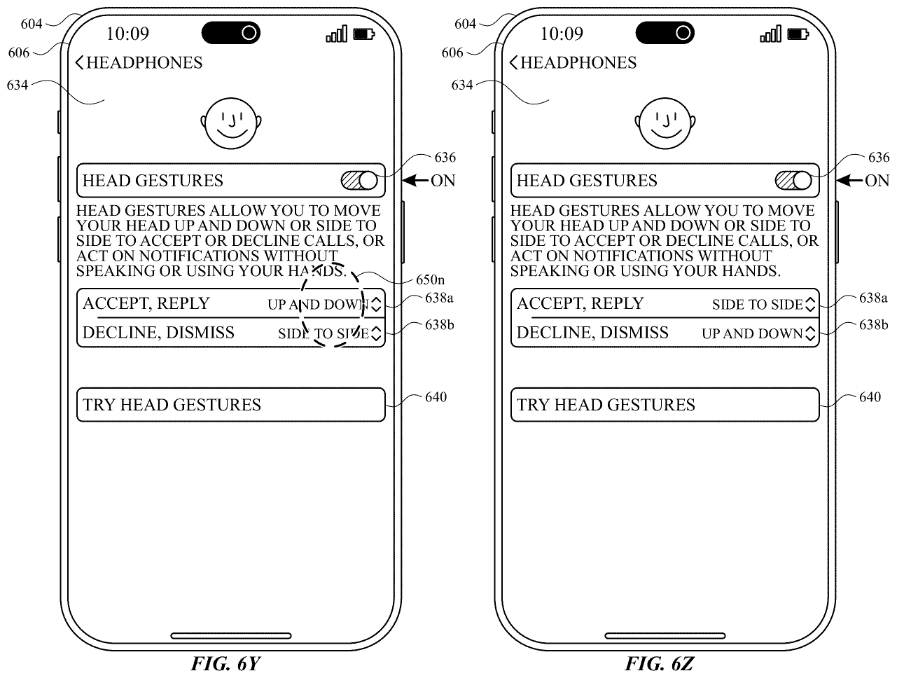

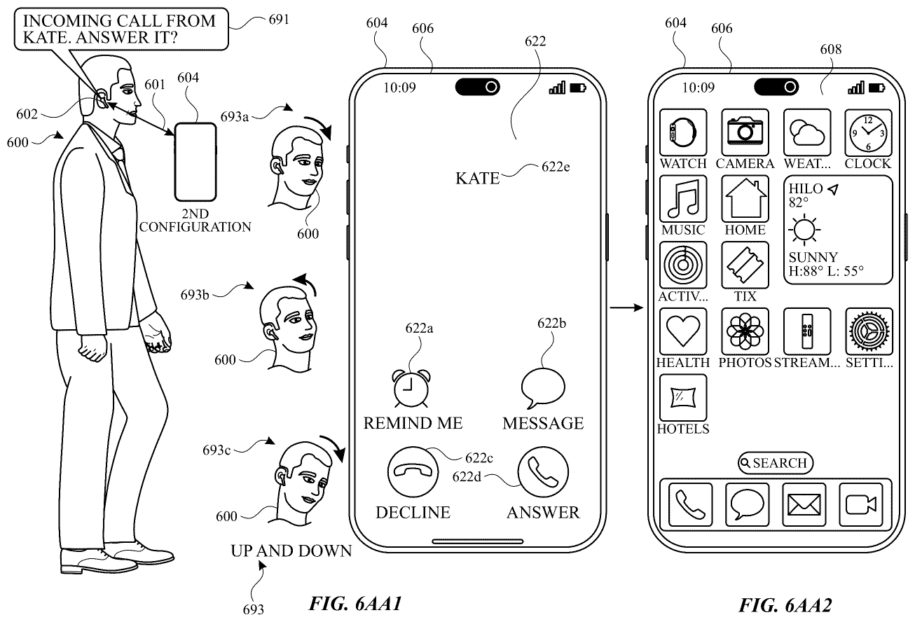

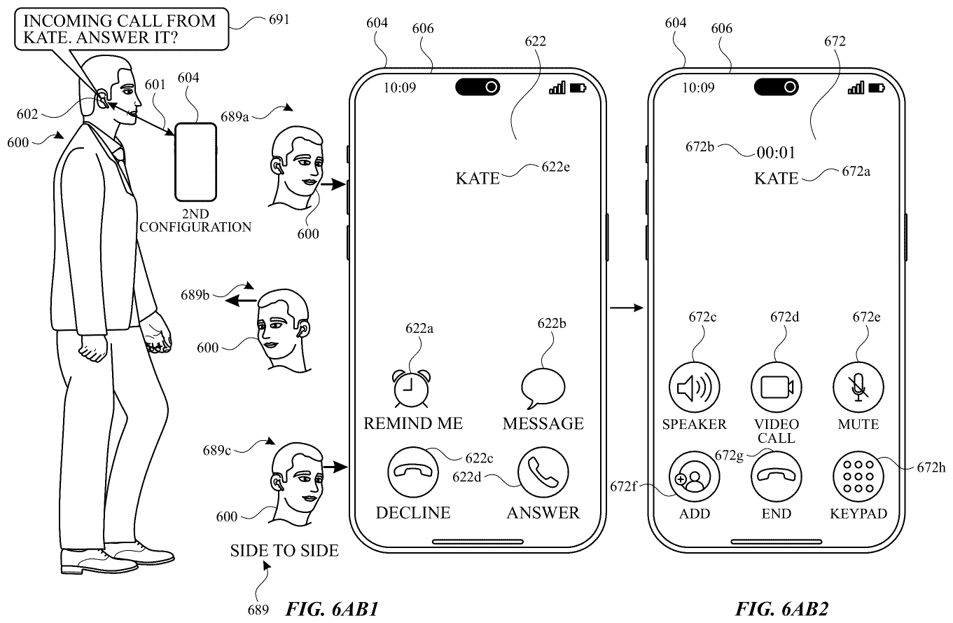

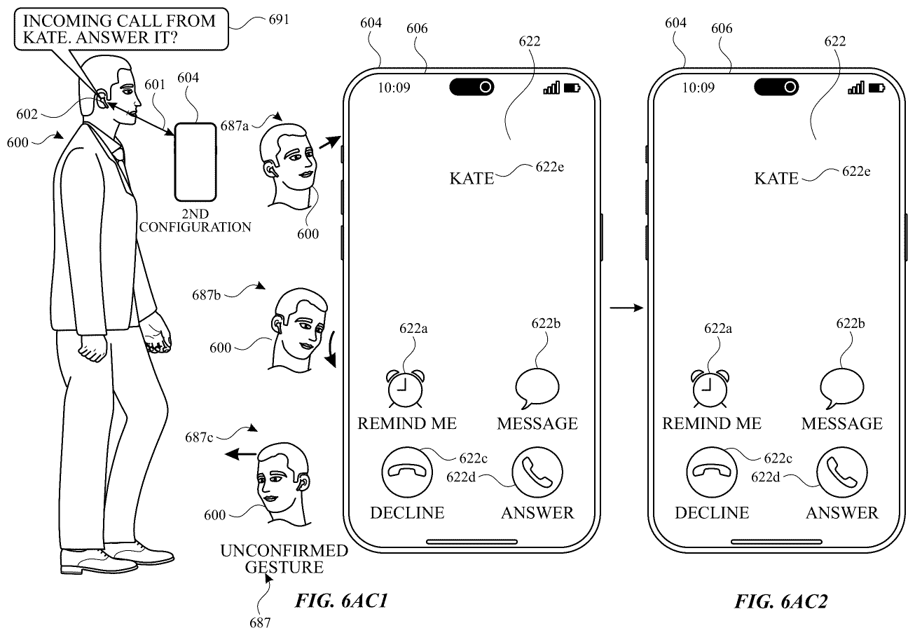

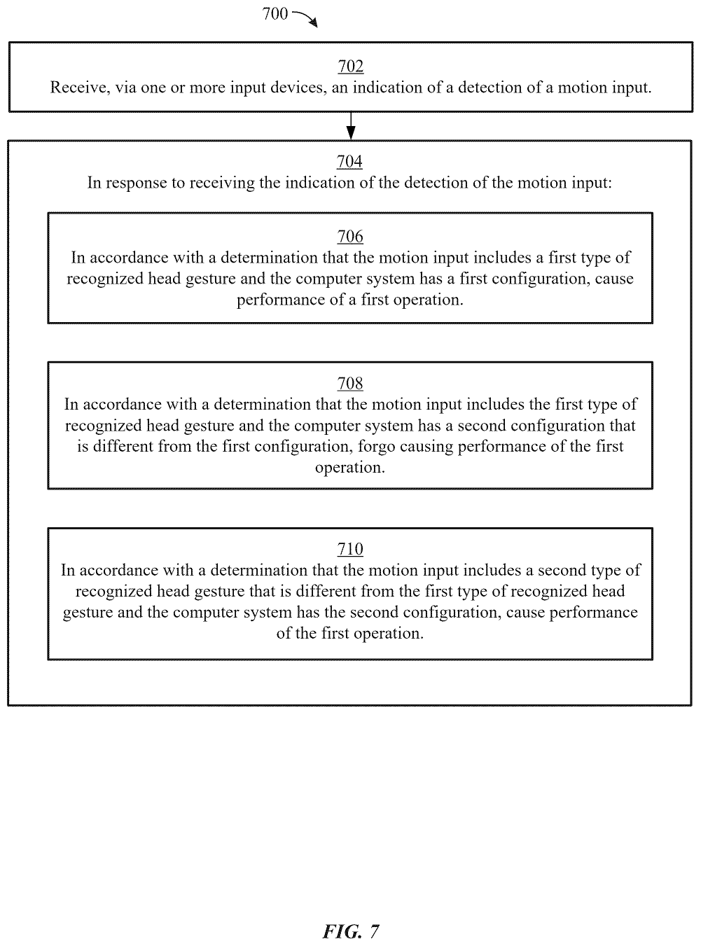

Below, FIGS. 1A-1B, 2, 3A-3G, 4A-4B, and 5A-5B provide a description of exemplary devices for performing operations in response to motion inputs. FIGS. 6A-6AC2 illustrate exemplary user interfaces for performing operations in response to motion inputs. FIG. 7 is a flow diagram illustrating methods of performing operations in response to motion inputs in accordance with some embodiments. The user interfaces in FIGS. 6A-6AC2 are used to illustrate the processes described below, including the processes in FIG. 7.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, increasing security and/or privacy, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

As used herein, the phrase “one or more of A and/or B” is construed to include all combinations of A and B, including, but not limited to: A individually without B; B individually without A; as well as a combination of A and B. The phrase “one or more of A, B, and/or C” is construed to include all combinations of A, B, and C, including, but not limited to: A individually without B and C; B individually without A and C; C individually without A and B; as well as any combinations of A, B, and/or C (e.g., A and B without C; A and C without B; B and C without A; and/or A, B, and C). Additionally, as used herein, the phrase “selected from the group consisting of A, B, C, and a combination thereof” and the phrase “at least one of A, B, and C” shall be construed to have the same meaning as the phrase “one or more of A, B, and/or C” as defined above. As used herein, the phrase “at least one of A, B, or C” and “one or more of A, B, or C” shall be construed to have the same meaning as the phrase “one or more of A, B, and/or C” as defined above. As used herein, the phrase “a combination including all of A, B, and C” is construed to include a combination of all the elements listed (e.g., a combination of A, B, and C).

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” or “touch screen display” for convenience and is sometimes known as or called a “touch-sensitive display.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

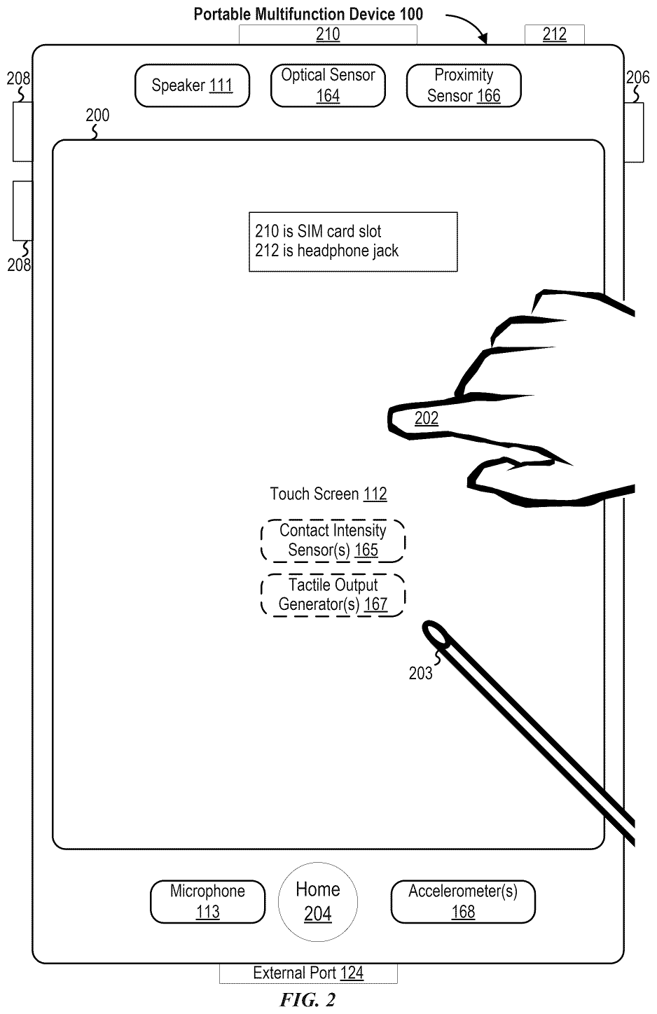

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. Nos. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

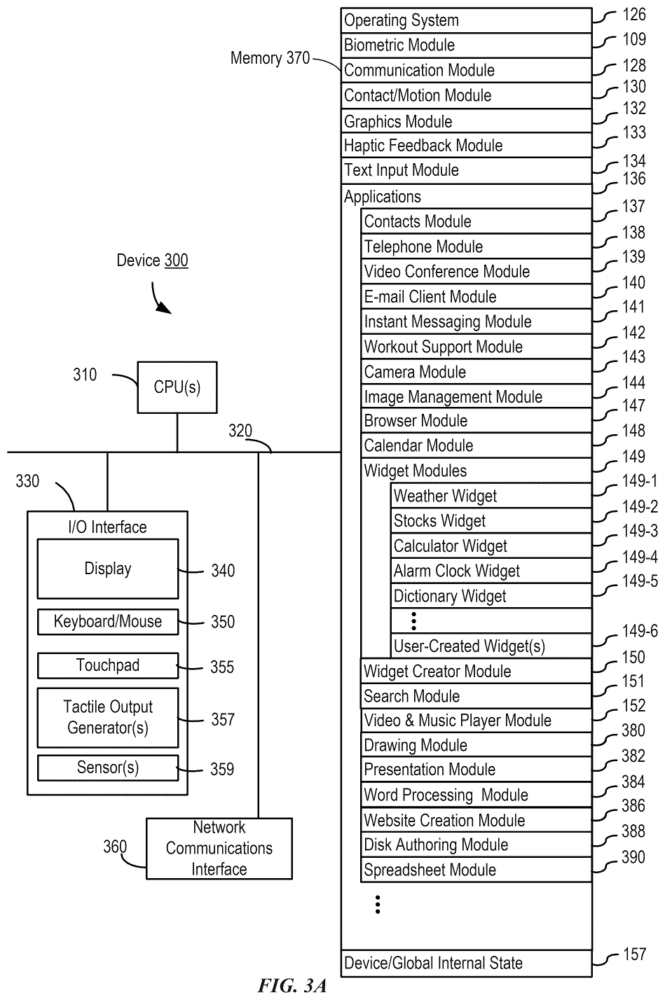

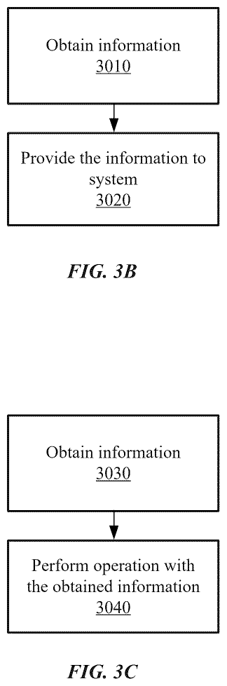

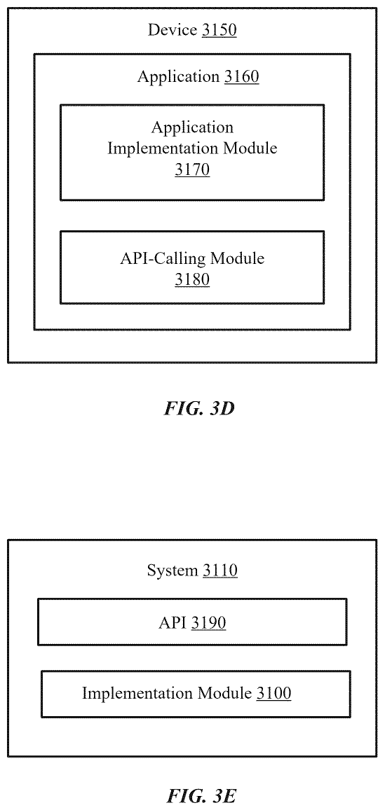

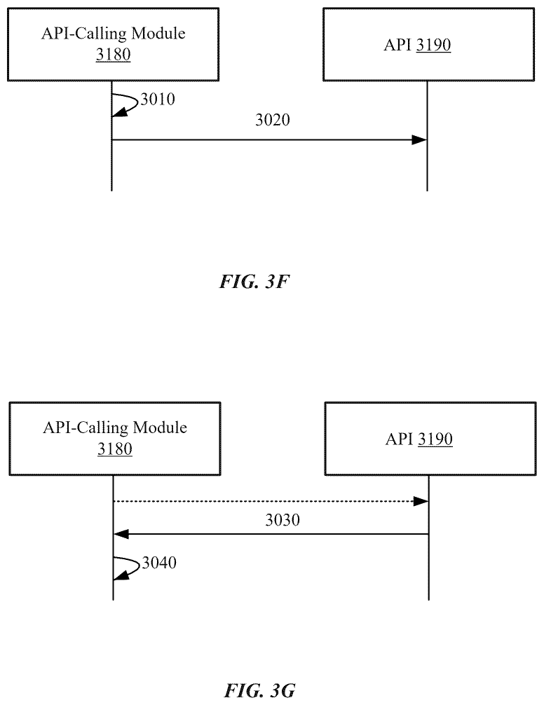

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

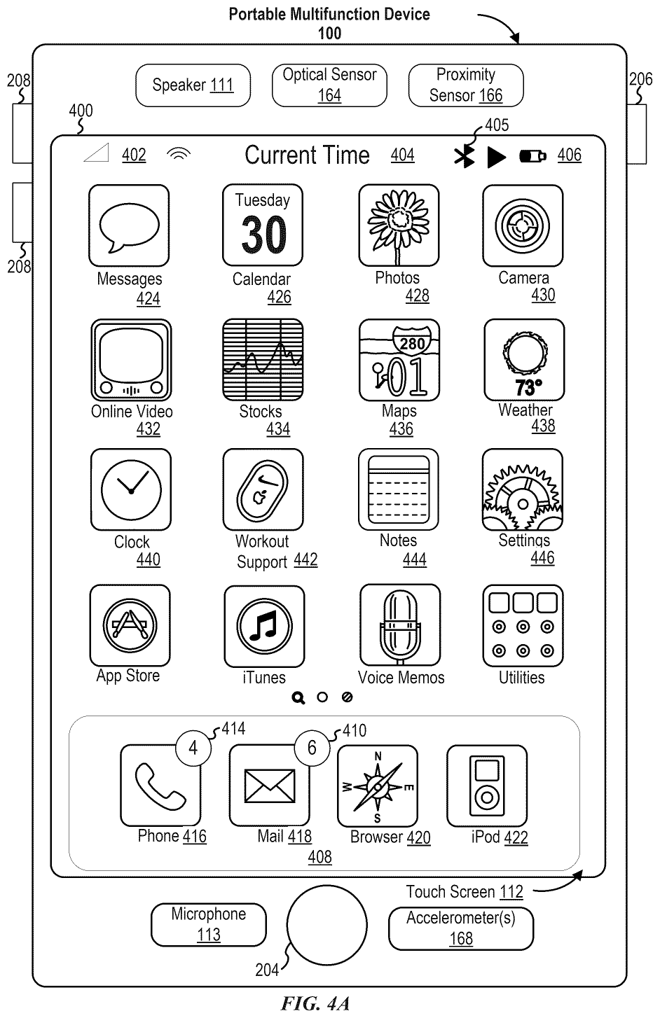

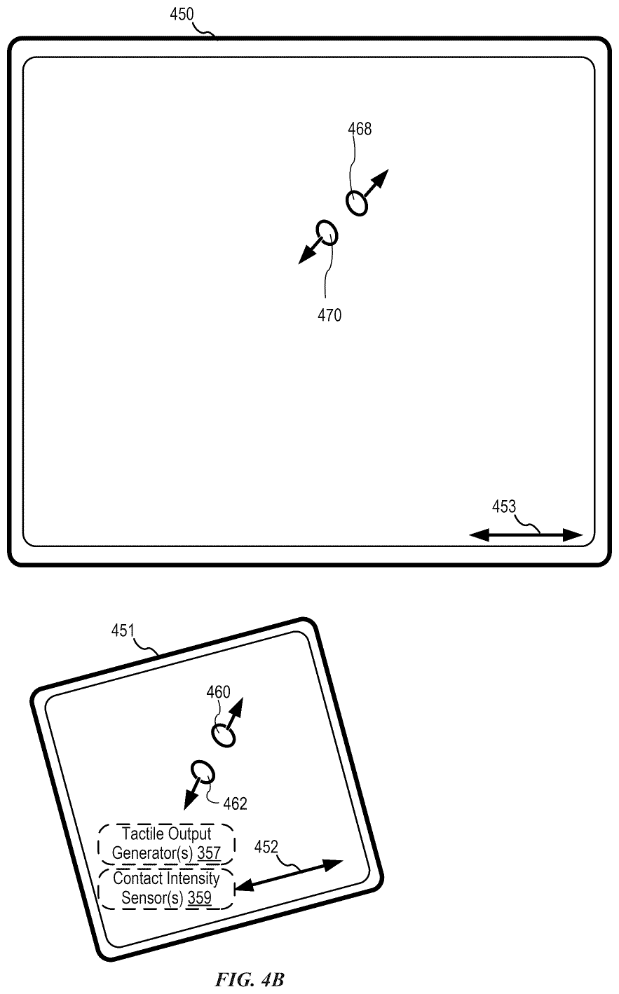

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

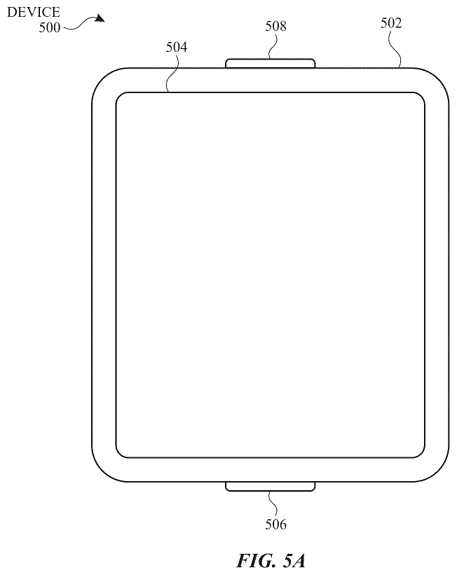

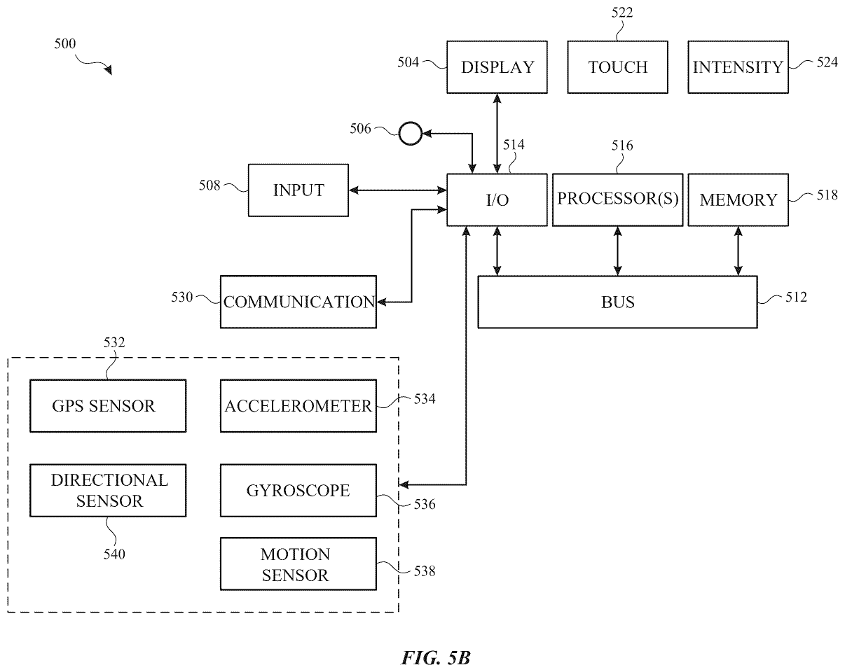

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including method 700 (FIG. 7). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

Attention is now directed towards embodiments of user interfaces (“UI”) and associated processes that are implemented on an electronic device, such as portable multifunction device 100, device 300, or device 500.

FIGS. 6A-6AC2 illustrate exemplary user interfaces for performing operations in response to motion inputs, in accordance with some embodiments. The user interfaces in these figures are used to illustrate the processes described below, including the processes in FIG. 7.

FIG. 6A illustrates user 600, device 602, and device 604. In the embodiment illustrated in FIG. 6A, device 602 is a pair of headphones that includes a pair of earbuds. In some embodiments, device 602 includes a pair of over-the-ear headphones, a head-mounted display (HMD) device, and/or other device that is configured to be worn on a user's head. Device 602 is configured to be worn by user 600 as shown in FIG. 6A.

Device 604 is capable of connecting (e.g., wirelessly) with device 602. In the embodiment illustrated in FIG. 6A, device 604 is a smartphone. In some embodiments, device 604 is a tablet computer, a laptop computer, a smartwatch, and/or a desktop computer. FIG. 6A illustrates a smaller-scale contextual view of device 604 (on the left) and an expanded view of device 604 (on the right) (e.g., different views of the same device). Device 604 includes display 606. FIG. 6A illustrates device 604 displaying user interface 608 (e.g., a home screen). In some embodiments, device 604 provides audio data to device 602 for output by device 602. For example, device 604 can receive a phone call and send audio of the phone call to device 602 for output by device 602. In some embodiments, device 604 receives a message and provides content of the message and/or audio data representing the message to device 602 for output by device 602. In some embodiments, device 602 is capable of performing communication such as, e.g., receiving and/or sending messages (e.g., without device 604).

In FIG. 6A, device 602 is not connected to device 604, as indicated by the broken line and the symbol between device 602 and device 604. In FIG. 6B, connection 601 is established between device 602 and device 604. In response to connection 601 being established between device 602 and device 604, device 604 displays user interface 610 (e.g., a pop up, sheet, and/or notification). In FIG. 6B, user interface 610 is displayed on top of and/or in front of at least a portion of user interface 608. In some embodiments, device 604 replaces display of user interface 608 with display of user interface 610.

User interface 610 displays information about features of device 602 (e.g., new features that were not available the last time device 602 connected to another device, such as device 604). In some embodiments, device 604 displays user interface 610 in response to a determination that a software update occurred (e.g., since the last time device 602 were used and/or connected to another device, such as device 604) that included the features identified in user interface 610. User interface 610 includes cancel option 612, continue option 614, and dismiss option 616. In response to detecting input 650a (e.g., a touch gesture and/or other selection input) corresponding to selection of cancel option 612 or an input (e.g., a touch gesture and/or other selection input) corresponding to selection of dismiss option 616, device 604 stops displaying user interface 610 (e.g., removes display of user interface 610 and/or displays user interface 608 without user interface 610).

In response to detecting input 650b (e.g., a touch gesture and/or other selection input) corresponding to selection of continue option 614, device 604 displays user interface 618 (e.g., ceases display of user interface 610 and/or replaces display of user interface 610 with display of user interface 618). User interface 618 displays additional information about one of the features included in user interface 610 (e.g., the first feature and/or a feature at a top of user interface 610). For instance, user interface 618 includes information about a feature that enables device 602 and/or device 604 to perform operations in response to motion inputs. For example, in FIG. 6C, user interface 618 includes information about a feature that enables device 602 and/or device 604 to respond to notifications, alerts, options, and/or prompts (e.g., by a virtual and/or digital assistant) in response to head gestures.

User interface 618 includes cancel option 612, dismiss option 616, and enable option 620. In response to detecting an input (e.g., a touch gesture and/or other selection input) corresponding to selection of cancel option 612 in user interface 618, device 604 removes display of user interface 618 without displaying information about another feature that was identified in user interface 610. In response to detecting an input (e.g., a touch gesture and/or other selection input) corresponding to selection of enable option 620 in user interface 618, device 604 enables device 602 and/or device 604 to perform operations in response to motion inputs and/or displays a user interface with an option to enable device 602 and/or device 604 to perform operations in response to motion inputs, such as, e.g., settings user interface 630 shown in FIG. 6F or head gestures settings user interface 634 shown in FIG. 6G. In response to detecting input 650c (e.g., a touch gesture and/or other selection input) corresponding to selection of dismiss option 616 in user interface 618, device 604 forgoes enabling device 602 and/or device 604 to perform operations in response to motion inputs (e.g., device 604 displays information about another feature that was identified in user interface 610 without enabling device 602 and/or device 604 to perform operations in response to motion inputs).

FIG. 6D1 illustrates an embodiment in which device 602 and/or device 604 have not been enabled to perform operations in response to motion inputs (e.g., dismiss option 616 was selected in FIG. 6C). In FIG. 6D1, device 604 receives an incoming phone call, as indicated by incoming call user interface 622 displayed on display 606. Incoming call user interface 622 includes call control options 622a-622d and caller indication 622e of the entity calling device 604. Call control options 622a-622d can be selected to perform respective call operations associated with the incoming call. For example, in response to detecting an input selecting reminder option 622a, a reminder event is created to call the entity making the incoming call; in response to detecting an input selecting message option 622b, a user interface is displayed for composing and/or sending a message to the entity making the incoming call; in response to detecting an input selecting decline option 622c, the call is declined (e.g., as described in FIGS. 6O1-6O2); and in response to detecting an input selecting answer option 622d, the call is answered (e.g., as described in FIGS. 6N1-6N2).

In some embodiments, device 604 does not display incoming call user interface 622 in response to receiving an incoming call (e.g., the incoming call described with reference to FIGS. 6D1-6D2, 6N1-6N2, 6O1-6O2, 6AA1-6AA2, 6AB1-6AB2, and/or 6AC1-6AC2). For example, in some embodiments, in response to receiving an incoming call, if device 604 is in a hand of user 600 in a lowered position (e.g., down by his side or leg), if device 604 is in a pocket of user 600, if device 604 is on a surface (e.g., with display 606 facing down), and/or if device 604 is away from user 600 (e.g., a threshold distance away from user 600), device 604 does not display incoming call user interface 622, displays incoming call user interface 622 with reduced brightness, and/or ceases display of incoming call user interface 622 after a threshold amount of time. In some such embodiments, user 600 is notified of the incoming call via an audio output (e.g., a notification, alert, and/or announcement) by device 602 and/or device 604. In some embodiments, in response to receiving the incoming call, device 602 and/or device 604 output an audio notification announcement (e.g., 624, 674, and/or 691) in addition to or instead of displaying incoming call user interface 622.

In FIG. 6D1, in response to receiving the incoming phone call, device 602 outputs audio notification announcement 624 (e.g., an audio notification and/or an audio alert) that there is an incoming call (e.g., “INCOMING CALL FROM KATE”). Notification announcement 624 includes an option (e.g., an audio option and/or an audio prompt) to take an action (e.g., to respond to notification announcement 624). For example, notification announcement 624 includes an option to answer the call (e.g., “ANSWER IT?”). After notification announcement 624 is output, user 600 performs motion input 626. Motion input 626 includes an up and down head gesture (e.g., a nod head gesture) represented by first state 626a of a head of user 600, second state 626b of the head of user 600 (e.g., which occurs after first state 626a), and third state 626c of the head of user 600 (e.g., which occurs after second state 626b). As described with reference to subsequent figures below, when device 602 and/or device 604 is configured to perform operations in response to motion inputs, motion input 626 causes an affirmative response, acceptance, and/or confirmation to the option in notification announcement 624, which causes the incoming call to be answered. In FIG. 6D1, however, because device 602 and/or device 604 are not currently enabled to perform operations in response to motion inputs, no operation is performed in response to motion input 626, as indicated by device 604 maintaining display of call user interface 622 in the same state as shown in FIG. 6D2. In some embodiments, device 602 does not output audio feedback (e.g., as described for motion input 660 with reference to FIG. 6K1) in response to detection of motion input 626 because device 602 and/or device 604 are not currently enabled to perform operations in response to motion inputs.

In FIG. 6E, device 604 displays user interface 608 (e.g., as described with reference to FIG. 6A) and detects input 650d (e.g., a touch gesture and/or other selection input) corresponding to selection of settings icon 628. In response to detecting input 650d, device 604 displays settings user interface 630 shown in FIG. 6F, which includes head gestures settings option 632. In response to detecting input 650e (e.g., a touch gesture and/or other selection input) corresponding to selection of head gestures settings option 632, device 604 displays head gestures settings user interface 634 shown in FIG. 6G.

Head gestures settings user interface 634 includes head gestures state option 636 (e.g., a toggle button and/or an on/off button), first head gesture configuration option 638a, second head gesture configuration option 638b, and head gestures tutorial option 640. First head gesture configuration option 638a indicates a type of recognized head gesture (e.g., “UP AND DOWN” also sometimes referred to as a nod gesture or a head nod gesture) that can be used to perform an accept operation and/or a reply operation. Second head gesture configuration option 638b indicates a type of recognized head gesture (e.g., “SIDE TO SIDE” also sometimes referred to as a shake gesture or a head shake gesture) that can be used to perform a decline operation and/or a dismiss operation. First head gesture configuration option 638a and/or second head gesture configuration option 638b can be selected via user input to change (e.g., switch) the type of recognized head gesture used to perform the operations of the corresponding option (e.g., as described with reference to FIGS. 6Y and 6Z). In some embodiments, the type of recognized head gesture that corresponds to a set of one or more operations is based on a region setting and/or language setting (e.g., of device 602 and/or device 604). For example, in some embodiments, the type of recognized head gestures indicated by first head gesture configuration option 638a and/or second head gesture configuration option 638b are based on a region setting (e.g., a user-selectable region setting and/or a geographic region in which device 604 is located, operating, and/or otherwise associated with) and/or a language setting (e.g., a user-selectable language setting and/or a language corresponding to a geographic region in which device 604 is located, operating, and/or otherwise associated with).

In FIG. 6G, head gestures state option 636 indicates that the functionality of performing operations in response to motion inputs is off or not enabled. In response to detecting input 650f (e.g., a touch gesture and/or other selection input) corresponding to selection of head gestures state option 636, the functionality of performing operations in response to motion inputs is turned on or enabled, as indicated in FIG. 6H.

In FIG. 6H, device 604 detects input 650g (e.g., a touch gesture and/or other selection input) corresponding to selection of head gestures tutorial option 640. In some embodiments, in accordance with a determination that an error condition is met (e.g., device 602 is not in a predetermined position and/or one or more earphones of device 602 are not on or in a user's ears), device 604 outputs a notification (e.g., an error notification) such as, e.g., notification 642 shown in FIG. 6I, with information on an action to take for operations to be performed in response to motion inputs. For example, notification 642 describes a position in which device 602 must be placed for operations to be performed in response to motion inputs (e.g., “YOU MUST HAVE BOTH HEADPHONES IN YOUR EARS”) and/or instructions for placing device 602 in a predetermined position (e.g., “PLACE BOTH HEADPHONES IN YOUR EARS TO TRY HEAD GESTURES”). In some embodiments, an error notification (e.g., notification 642) is output in accordance with a determination that the error condition is met even when the tutorial is not being provided. For example, in some embodiments, an error notification (e.g., notification 642) is output if the error condition is met when user 600 performs motion input 670 in FIG. 6N1, motion input 685 in FIG. 6O1, motion input 680 in FIG. 6P, motion input 688 in FIG. 6S1, motion input 692 in FIG. 6T1, motion input 696 in FIG. 6U, motion input 683 in FIG. 6W, motion input 697 in FIG. 6X1, motion input 693 in FIG. 6AA1, and/or motion input 689 in FIG. 6AB1. In response to detecting input 650h (e.g., a touch gesture and/or other selection input) corresponding to selection of confirmation option 644, device 604 removes display of notification 642.

In response to detecting input 650g and, optionally, in accordance with a determination that the error condition is not met, device 604 provides a tutorial for performing one or more types of recognized head gestures that can cause device 602 and/or device 604 to perform corresponding operations. In FIG. 6J, device 604 displays an embodiment of an initial user interface 646a of the tutorial. User interface 646 includes information 652, continue option 654, and cancel option 648. Information 652 includes information about the one or more types of recognized head gestures and the corresponding operations that the recognized head gestures cause to be performed. In response to detecting input 650i (e.g., a touch gesture and/or other selection input) corresponding to selection of cancel option 648 in user interface 646a, device 604 cancels the tutorial (e.g., removes display of user interface 646 and displays head gestures settings user interface 634). In response to detecting input 650j (e.g., a touch gesture and/or other selection input) corresponding to selection of continue option 654 in user interface 646a, device 604 continues the tutorial and displays instructions for performing a first type of recognized head gesture (e.g., an up and down gesture and/or a head nod gesture), as shown in FIG. 6K1.

In FIG. 6K1, device 604 displays user interface 646b, including graphical instructions 656a for performing the first type of recognized head gesture, textual instructions 656b for performing the first type of recognized head gesture, description 656c of one or more operations that can be performed in response to the first type of recognized head gesture, and continue option 654. In some embodiments, continue option 654 is disabled (e.g., greyed out and/or cannot be selected) until the first type of head gesture is detected (e.g., the user must perform the first type of head gesture in order for the tutorial to proceed). While displaying user interface 646b in FIG. 6K1, user 600 performs motion input 660 corresponding to the first type of recognized head gesture. Motion input 660 includes first state 660a (e.g., a head of user 600 is tilted forward), second state 660b (e.g., the head of user 600 is tilted back, which occurs after first state 660a), and third state 660c (e.g., the head of user 600 is tilted forward again, which occurs after second state 660b).

In some embodiments, device 602 outputs audio as motion input 660 progresses to provide feedback to user 600 that the first type of recognized head gesture is being detected. For example, device 602 outputs audio 662a in response to detection of first state 660a, audio 662b in response to detection of second state 660b, and audio 662c in response to detection of third state 660c. Audio 662a and audio 662b provide feedback to user 600 that motion input 660 is successfully progressing towards completion of the first type of recognized head gesture. In some embodiments, device 602 does not output audio 662b and/or audio 662c in accordance with a determination that second state 660b and/or third state 660c do not correspond to the first type of recognized head gesture. In some embodiments, device 602 outputs audio (e.g., an error sound) different from audio 662b and/or audio 662c in accordance with a determination that second state 660b and/or third state 660c do not correspond to the first type of recognized head gesture to provide feedback to user 600 that the first type of recognized head gesture was not detected (e.g., the first type of recognized head gesture was not successfully performed). In some embodiments, audio 662a is the same as audio 662b. In some embodiments, audio 662a is different from audio 662b. Audio 662c is different from audio 662a and/or audio 662b to provide confirmation that the first type of recognized head gesture has been detected.

In response to detection of motion input 660 and a determination that motion input 660 includes the first type of recognized head gesture, device 604 outputs first head gesture confirmation indicator 656d (e.g., device 604 replaces display of graphical instructions 656a with display of first head gesture confirmation indicator 656d) and enables continue option 654, as shown in FIG. 6K2. In response to detecting input 650k (e.g., a touch gesture and/or other selection input) corresponding to selection of continue option 654, device 604 displays user interface 646c, including graphical instructions 656e for performing the second type of recognized head gesture, textual instructions 656f for performing the second type of recognized head gesture, description 656g of one or more operations that can be performed in response to detection of the second type of recognized head gesture, and continue option 654, as shown in FIG. 6L1. In some embodiments, continue option 654 is disabled (e.g., greyed out and/or cannot be selected) in user interface 646c until the second type of head gesture is detected (e.g., the user must perform the second type of head gesture for the tutorial to proceed). While displaying user interface 646c in FIG. 6L1, user 600 performs motion input 664 (e.g., a side-to-side and/or head shake gesture) corresponding to the second type of recognized head gesture.

Motion input 664 includes first state 664a (e.g., the head of user 600 is turned to the right), second state 664b (e.g., the head of user 600 is turned to the left, which occurs after first state 664a), and third state 664c (e.g., the head of user 600 is turned back to the right, which occurs after second state 664b). Device 602 outputs audio 666a in response to detection of first state 664a, audio 666b in response to detection of second state 664b, and audio 666c in response to detection of third state 664c. Audio 666a and audio 666b provide feedback to user 600 that motion input 664 is successfully progressing towards completion of the second type of recognized head gesture. In some embodiments, device 602 does not output audio 666b and/or audio 666c in accordance with a determination that second state 664b and/or third state 664c does not correspond to the second type of recognized head gesture. In some embodiments, device 602 outputs audio (e.g., an error sound) different from audio 666b and/or audio 666c in accordance with a determination that second state 664b and/or third state 664c do not correspond to the second type of recognized head gesture to provide feedback to user 600 that the second type of recognized head gesture was not detected (e.g., the second type of recognized head gesture was not successfully performed). In some embodiments, audio 666a is the same as audio 666b, audio 662a, and/or audio 662b. In some embodiments, audio 666a is different from audio 662b, audio 662a, and/or audio 662b. Audio 666c is different from audio 666a and/or audio 666b to provide confirmation that the second type of recognized head gesture has been detected. In some embodiments, audio 666c is the same as audio 662c (e.g., the same confirmation sound as for the first type of recognized head gesture).

In response to detection of motion input 664 and a determination that motion input 664 includes the second type of recognized head gesture, device 604 outputs second head gesture confirmation indicator 656h (e.g., device 604 replaces display of graphical instructions 656e with display of second head gesture confirmation indicator 656h) and displays done option 658 (or, in some embodiments, enables continue option 645), as shown in FIG. 6L2. In response to detecting input 650l (e.g., a touch gesture and/or other selection input) corresponding to selection of done option 658, device 604 displays (e.g., re-displays and/or returns to) head gestures settings user interface 634.

FIG. 6M1 illustrates an embodiment in which device 602 and/or device 604 are in a first configuration in which device 602 and/or device 604 are enabled to perform operations in response to detection of motion inputs (e.g., as a result of head gestures state option 636 being enabled in FIGS. 6G and 6H). According to the first configuration, device 602 and/or device 604 are enabled to perform operations in response to detection of motion inputs (e.g., as represented by the state of head gestures state option 636 being ON), an up and down head gesture corresponds to an accept operation and a reply operation (e.g., as represented by first head gesture configuration option 638a in FIGS. 6G and 6H), and a side to side head gesture corresponds to a decline operation and a dismiss operation (e.g., as represented by second head gesture configuration option 638b in FIGS. 6G and 6H).

In some embodiments, performance of a motion input corresponding to a recognized type of head gesture does not cause device 602 and/or device 604 to perform a corresponding operation if the motion input is performed at a time that is not within a threshold amount of time of a notification that can be responded to by detecting a motion input including a recognized type of head gesture (e.g., even though device 602 and/or device 604 are enabled to perform operations in response to motion inputs). For example, while device 602 and/or device 604 are in the first configuration, motion input 668 corresponding to a recognized type of head gesture (e.g., the first type of recognized head gesture and/or an up and down head gesture) is performed at a time when a notification is not being output (e.g., a threshold amount of time has elapsed since output of a notification that can be responded to with a motion input). In some embodiments, motion input 668 (e.g., including states 668a, 668b, and 668c) corresponds to (e.g., is the same as and/or includes characteristics of) motion input 660 described in FIG. 6K1. Because motion input 668 is not associated with (e.g., is not detected within a threshold amount of time of) a notification that can be responded to with a motion input, device 602 and/or device 604 does not perform an operation corresponding to motion input 668 (e.g., device 602 and/or device 604 do not perform an accept operation or a reply operation), as illustrated by device 604 maintaining display of user interface 608 in FIG. 6M2. In some embodiments, device 602 does not output audio feedback (e.g., as described for motion input 660 with reference to FIG. 6K1) in response to detection of motion input 668 because motion input 668 is not associated with a notification that can be responded to with a motion input.

FIG. 6N1 illustrates an embodiment in which device 602 and/or device 604 are in the first configuration described with reference to FIG. 6M1 (e.g., the configuration represented by the state of the settings in FIG. 6H). In FIG. 6N1, device 604 receives an incoming phone call, as indicated by incoming call user interface 622 displayed on display 606. Incoming call user interface 622 is described above with reference to FIG. 6D1. In response to receiving the incoming phone call, device 602 outputs audio notification announcement 674 that there is an incoming call (e.g., “INCOMING CALL FROM KATE”). Notification announcement 674 includes an option and/or a prompt to take an action. For example, notification announcement 674 includes an option to answer the call (e.g., “ANSWER IT?”). In some embodiments, the incoming call in FIG. 6N1 is the same call as described with reference to FIG. 6D1 and notification announcement 674 is the same notification announcement as notification announcement 624 described with reference to FIG. 6D1.

After notification announcement 674 is output, user 600 performs motion input 670, which includes an up and down head gesture represented by first state 670a of the head of user 600, second state 670b of the head of user 600 (e.g., which occurs after first state 670a), and third state 670c of the head of user 600 (e.g., which occurs after second state 670b). In some embodiments, motion input 670 corresponds to (e.g., is the same as and/or includes characteristics of) motion input 660 described in FIG. 6K1. In some embodiments, device 602 outputs audio 662a, audio 662b, and/or audio 662c in response to detecting first state 670a, second state 670b, and/or third state 670c, respectively (e.g., as described for motion input 660 with reference to FIG. 6K1). In response to detection of motion input 670 and in accordance with a determination that motion input 670 includes the first type of recognized head gesture and that device 602 and/or device 604 have the first configuration, device 604 answers and/or accepts the incoming call, as illustrated by display of active call user interface 672 displayed on device 604 in FIG. 6N2. In some embodiments, motion input 670 must be detected within a threshold amount of time of notification announcement 674 (e.g., in accordance with a determination that less than the threshold amount of time has elapsed since output of notification announcement 674) to cause the call to be answered in response to detection of motion input 670.

In some embodiments, a call can be answered in response to detection of other types of inputs. For example, in response to detection (e.g., by device 604) of input 650m (e.g., a touch gesture and/or other selection input) corresponding to selection of answer option 622d in FIG. 6N1, device 604 answers and/or accepts the incoming call. As another example, in response to detection (e.g., by device 602) of input 650p (e.g., a first type of press input and/or a press input that includes only a single press), device 604 answers and/or accepts the incoming call.

FIG. 6O1 illustrates device 604 receiving an incoming phone call (e.g., the same incoming phone call as described with reference to FIG. 6N1), as indicated by incoming call user interface 622 displayed on display 606. Incoming call user interface 622 is described above with reference to FIG. 6D1 and FIG. 6N1. Device 602 and/or device 604 are in the first configuration described with reference to FIG. 6M1 and/or FIG. 6N1 (e.g., the configuration represented by the state of the settings in FIG. 6H). In response to receiving the incoming phone call, device 602 outputs audio notification announcement 674 (e.g., the same notification announcement 674 described with reference to FIG. 6N1). After notification announcement 674 is output, user 600 performs motion input 685 (e.g., instead of motion input 670 described with reference to FIG. 6N1). Motion input 685 includes a side to side head gesture represented by first state 685a of the head of user 600, second state 685b of the head of user 600 (e.g., which occurs after first state 685a), and third state 685c of the head of user 600 (e.g., which occurs after second state 685b). In some embodiments, motion input 685 corresponds to (e.g., is the same as and/or includes characteristics of) motion input 664 described in FIG. 6L1. In some embodiments, device 602 outputs audio 666a, audio 666b, and/or audio 666c in response to detecting first state 685a, second state 685b, and/or third state 685c, respectively (e.g., as described for motion input 664 with reference to FIG. 6L1). In response to detection of motion input 685 and in accordance with a determination that motion input 685 includes the second type of recognized head gesture and that device 602 and/or device 604 have the first configuration, device 604 declines and/or dismisses the incoming call, as illustrated by display of user interface 608 displayed on device 604 in FIG. 602 (e.g., dismissing the incoming call includes ceasing display of incoming call user interface 622). In some embodiments, motion input 685 must be detected within a threshold amount of time of notification announcement 674 (e.g., in accordance with a determination that less than the threshold amount of time has elapsed since output of notification announcement 674) to cause the call to be dismissed in response to detection of motion input 685.

In some embodiments, a call can be declined and/or dismissed in response to detection of other types of inputs. For example, in response to detection (e.g., by device 604) of input 6500 (e.g., a touch gesture and/or other selection input) corresponding to selection of decline option 622c in FIG. 6O1, device 604 declines the incoming call. As another example, in response to detection (e.g., by device 602) of input 650q (e.g., a second type of press input and/or a double press input that includes two presses within a threshold amount of time), device 604 declines the incoming call.

In some embodiments, in response to detection of a motion input corresponding to a request to decline an incoming call (e.g., motion input 685), device 602 and/or device 604 provides a set of one or more options. In some embodiments, in response to detection of motion input 685 in FIG. 6O1, device 604 displays a messaging option (e.g., message option 622b and/or other selectable option), and in response to detecting selection of the messaging option, initiates a process for composing and/or sending a message to the caller (e.g., Kate) of the declined call (e.g., device 604 displays messaging user interface 676 for messaging Kate as shown in FIG. 6P). In some embodiments, in response to detection of motion input 685 in FIG. 601, device 602 outputs an audio messaging option (e.g., “SEND A TEXT MESSAGE TO KATE?”), and in response to detecting a motion input (e.g., motion input 660) accepting the audio messaging option, initiates a process for composing and/or sending a message to the caller (e.g., Kate) of the declined call. For example, in response to acceptance of the audio messaging option, device 602 can create a message based on voice inputs from user 600 (e.g., as described in FIGS. 6V1-6V2) and/or send a message to the caller (e.g., Kate) of the declined call in response to detection of a voice input (e.g., “YES” and/or “SEND”) and/or a motion input (e.g., motion input 660 and/or other motion input corresponding to an accept operation). In some embodiments, in response to detection of motion input 685 in FIG. 6O1, device 604 displays a callback option (e.g., a notification, a call button, and/or a reminder option, such as reminder option 622a, to call the caller of the declined call at a later time), and in response to detecting selection of the callback option, initiates a process for calling the caller (e.g., Kate) of the declined call (e.g., device 604 displays an outgoing call user interface and/or sets a reminder). In some embodiments, in response to detection of motion input 685 in FIG. 6O1, device 602 outputs an audio callback option (e.g., “CALLBACK KATE?” and/or “SET A REMINDER TO CALL KATE?”), and in response to detecting a motion input (e.g., motion input 660) accepting the audio callback option, initiates a process for calling the caller (e.g., Kate) of the declined call (e.g., initiates an outgoing call to Kate and/or sets a reminder to call Kate).

FIG. 6P illustrates an embodiment in which device 602 and/or device 604 are in the first configuration described with reference to FIG. 6M1 (e.g., the configuration represented by the state of the settings in FIG. 6H). In FIG. 6P, device 604 receives message 676a (e.g., a text message), as shown in messaging user interface 676 displayed on display 606. Message 676a includes content (e.g., “COULD YOU SEND ME THE SLIDES WHEN YOU GET TO THE STUDIO?”). In response to receiving message 676a, device 602 begins outputting audio notification announcement 678 corresponding to message 676a. Outputting notification announcement 678 includes reading content of message 676a aloud. While device 602 is outputting notification announcement 678 (e.g., before notification announcement 678 is completed), motion input 680 is detected. For example, in FIG. 6P, motion input 680 is detected after outputting first portion 678a (e.g., “NEW MESSAGE FROM KATE. COULD YOU SEND ME”) of notification announcement 678. Notably, message 676a includes content (e.g., “THE SLIDES WHEN YOU GET TO THE STUDIO?”) that has not been read in notification announcement 678 at the time of motion input 680. Motion input 680 includes a side to side head gesture represented by first state 680a of the head of user 600, second state 680b of the head of user 600 (e.g., which occurs after first state 680a), and third state 680c of the head of user 600 (e.g., which occurs after second state 680b). In some embodiments, motion input 680 corresponds to (e.g., is the same as and/or includes characteristics of) motion input 664 described in FIG. 6L1. In some embodiments, device 602 outputs audio 666a, audio 666b, and/or audio 666c in response to detecting first state 680a, second state 680b, and/or third state 680c, respectively (e.g., as described for motion input 664 with reference to FIG. 6L1).

In some embodiments, device 604 does not display messaging user interface 676 in response to receiving a message (e.g., message 676a in FIGS. 6P-6S1, message 676b in FIG. 6T1, message 676d in FIG. 6U, and/or message 676f in FIG. 6W). For example, in some embodiments, in response to receiving a message, if device 604 is in a hand of user 600 in a lowered position (e.g., down by his side or leg), if device 604 is in a pocket of user 600, if device 604 is on a surface (e.g., with display 606 facing down), and/or if device 604 is away from user 600 (e.g., a threshold distance away from user 600), device 604 does not display messaging user interface 676, displays messaging user interface 676 with reduced brightness, and/or ceases display of messaging user interface 676 after a threshold amount of time. In some such embodiments, user 600 is notified of the message via an audio notification announcement output by device 602 and/or device 604. In some embodiments, in response to receiving a message, device 602 and/or device 604 output an audio notification announcement (e.g., 678, 690, 694, 695, and/or 699) in addition to or instead of displaying messaging user interface 676.

In response to detection of motion input 680 and in accordance with a determination that motion input 680 includes the second type of recognized head gesture and that device 602 and/or device 604 have the first configuration, device 602 stop outputting and/or dismiss audio notification announcement 678 (e.g., before the entire content of notification announcement 678 and/or message 676a is output), as illustrated by device 602 not outputting notification announcement 678 in FIG. 6Q. In some embodiments, motion input 680 must be detected within a threshold amount of time of notification announcement 678 (e.g., in accordance with a determination that less than the threshold amount of time has elapsed since output of notification announcement 678) to stop notification announcement 678 in response to detection of motion input 680.

FIG. 6R illustrates an embodiment in which device 602 and/or device 604 are in the first configuration described with reference to FIG. 6M1 (e.g., the configuration represented by the state of the settings in FIG. 6H). In FIG. 6R, device 604 receives message 676a as described with reference to FIG. 6P. In response to receiving message 676a, device 602 begins outputting audio notification announcement 678 corresponding to message 676a as described with reference to FIG. 6P. In contrast to FIG. 6P, a motion input corresponding to a request to stop output of notification announcement 678 is not detected while device 602 is outputting notification announcement 678 (e.g., after outputting first portion 678a and/or before notification announcement 678 is completed). Because a motion input corresponding to a request to stop output of notification announcement 678 is not detected, device 602 does not stop outputting and/or does not dismiss audio notification announcement 678. As a result, device 602 continues outputting notification announcement 678, as illustrated by device 602 outputting second portion 678b (e.g., “THE SLIDES WHEN YOU GET TO THE STUDIO? ADD A REMINDER?”) of notification announcement 678 in FIG. 6S1. Notably, second portion 678b of notification announcement 678 includes an option (e.g., “ADD A REMINDER?”) to add a reminder based on message 676a (e.g., content of message 676a, a time of message 676a, and/or a sender of message 676a). In some embodiments, a notification announcement includes an option to add a reminder in accordance with a determination that message 676a satisfies a set of reminder criteria. For example, message 676a includes a request to perform a task (e.g., “COULD YOU SEND ME THE SLIDES”) that causes notification announcement 678 to include the option to add the reminder for the task.

In FIG. 6S1, after notification announcement 678 is output (e.g., including option “ADD A REMINDER?”), user 600 performs motion input 688. Motion input 688 includes an up and down head gesture (e.g., a nod head gesture) represented by first state 688a of a head of user 600, second state 688b of the head of user 600 (e.g., which occurs after first state 688a), and third state 688c of the head of user 600 (e.g., which occurs after second state 688b). In some embodiments, motion input 688 corresponds to (e.g., is the same as and/or includes characteristics of) motion input 660 described in FIG. 6K1. In some embodiments, device 602 outputs audio 662a, audio 662b, and/or audio 662c in response to detecting first state 688a, second state 688b, and/or third state 688c, respectively (e.g., as described for motion input 660 with reference to FIG. 6K1). In response to detection of motion input 688 and a determination that motion input 688 includes the first type of recognized head gesture and that device 602 and/or device 604 has the first configuration, a reminder is generated and/or added to an account and/or device associated with the user of device 604. For example, in response to detection of motion input 688, reminder 686 (e.g., “SEND SLIDES TO KATE”) is created and added to a list of reminders, as illustrated in user interface 684 on device 604 shown in FIG. 6S2. In some embodiments, motion input 688 must be detected within a threshold amount of time of notification announcement 678 (e.g., in accordance with a determination that less than the threshold amount of time has elapsed since output of notification announcement 678) to create reminder 686 in response to detection of motion input 688.

FIG. 6T1 illustrates an embodiment in which device 602 and/or device 604 are in the first configuration described with reference to FIG. 6M1 (e.g., the configuration represented by the state of the settings in FIG. 6H). In FIG. 6T1, device 604 receives message 676b (e.g., a text message), as shown in messaging user interface 676 displayed on display 606. Message 676b includes content (e.g., “WHAT'S YOUR FLIGHT NUMBER?”). In response to receiving message 676b, device 602 outputs audio notification announcement 690 corresponding to message 676b. Notification announcement 690 includes an option (e.g., “REPLY WITH ES20?”) to send a suggested response to message 676b. In some embodiments, device 604 generates and/or provides a suggested response based on the content of a received message (e.g., message 676b) and information associated with user 600, such as, for example, a calendar event, text messages, emails, user preferences, and/or search queries. For example, in some embodiments, based on the content of message 676b, a flight number (e.g., “ES20”) included in a calendar event and/or a flight confirmation email of user 600 is provided as a suggested reply to message 676b.

After notification announcement 690 is output (e.g., including option “REPLY WITH ES20?”), user 600 performs motion input 692. Motion input 692 includes an up and down head gesture (e.g., a nod head gesture) represented by first state 692a of a head of user 600, second state 692b of the head of user 600 (e.g., which occurs after first state 692a), and third state 692c of the head of user 600 (e.g., which occurs after second state 692b). In some embodiments, motion input 692 corresponds to (e.g., is the same as and/or includes characteristics of) motion input 660 described in FIG. 6K1. In some embodiments, device 602 outputs audio 662a, audio 662b, and/or audio 662c in response to detecting first state 692a, second state 692b, and/or third state 692c, respectively (e.g., as described for motion input 660 with reference to FIG. 6K1). In response to detection of motion input 692 and a determination that motion input 692 includes the first type of recognized head gesture and that device 602 and/or device 604 has the first configuration, the suggested message (e.g., “ES20”) is sent in reply to message 676b (e.g., to the sender of message 686b), as illustrated by message 676c in messaging user interface 676 shown in FIG. 6T2. In some embodiments, motion input 692 must be detected within a threshold amount of time of notification announcement 690 (e.g., in accordance with a determination that less than the threshold amount of time has elapsed since output of notification announcement 690) to select and/or send the suggested response in response to detection of motion input 692.

FIG. 6U illustrates an embodiment in which device 602 and/or device 604 are in the first configuration described with reference to FIG. 6M1 (e.g., the configuration represented by the state of the settings in FIG. 6H). In FIG. 6U, device 604 receives message 676d (e.g., a text message), as shown in messaging user interface 676 displayed on display 606. Message 676d includes content (e.g., “WHERE DO YOU WANT TO GO FOR DINNER?”). In response to receiving message 676d, device 602 outputs audio notification announcement 694 corresponding to message 676d. Notification announcement 694 includes an option (e.g., “REPLY?”) to reply to message 676d. In contrast to notification announcement 690 in FIG. 6T1, notification announcement 694 does not include a suggested reply.

After notification announcement 694 is output (e.g., including option “REPLY?”), user 600 performs motion input 696. Motion input 696 includes an up and down head gesture (e.g., a nod head gesture) represented by first state 696a of a head of user 600, second state 696b of the head of user 600 (e.g., which occurs after first state 696a), and third state 696c of the head of user 600 (e.g., which occurs after second state 696b). In some embodiments, motion input 696 corresponds to (e.g., is the same as and/or includes characteristics of) motion input 660 described in FIG. 6K1. In some embodiments, device 602 outputs audio 662a, audio 662b, and/or audio 662c in response to detecting first state 696a, second state 696b, and/or third state 696c, respectively (e.g., as described for motion input 660 with reference to FIG. 6K1).

In response to detection of motion input 696 and a determination that motion input 696 includes the first type of recognized head gesture and that device 602 and/or device 604 has the first configuration, device 602 and/or device 604 activate an audio input mode in which device 602 and/or device 604 can receive audio input, such as verbal dictation from user 600, that is used to generate and/or send a message in response to message 676d. For example, in FIG. 6V1, while device 602 and/or device 604 are enabled to receive audio input, speech input 698 (e.g., “LET'S GO TO A STEAKHOUSE”) spoken by user 600 is detected. In response to detection of speech input 698, a message including the content of speech input 698 (e.g., “LET'S GO TO A STEAKHOUSE”) is generated and/or sent in reply to message 676d (e.g., to the sender of message 676d), as illustrated by message 676e in messaging user interface 676 shown in FIG. 6V2. In some embodiments, motion input 696 must be detected within a threshold amount of time of notification announcement 694 (e.g., in accordance with a determination that less than the threshold amount of time has elapsed since output of notification announcement 694) to activate the audio input mode in response to detection of motion input 696.

FIG. 6W illustrates an embodiment in which device 602 and/or device 604 are in the first configuration described with reference to FIG. 6M1 (e.g., the configuration represented by the state of the settings in FIG. 6H). In FIG. 6W, device 604 receives message 676f (e.g., a text message), as shown in messaging user interface 676 displayed on display 606. Message 676f includes content (e.g., “I'M TRYING TO DECIDE WHERE TO GO FOR DINNER BUT CAN'T MAKE UP MY MIND. DO YOU HAVE ANY IDEAS?”). In response to receiving message 676f and in accordance with a determination that message 676f satisfies a set of one or more summary criteria, device 602 outputs audio notification announcement 699, which includes a summary of message 676f (e.g., instead of the complete content of message 676f). For example, notification announcement 699 includes summary “KATE SENT A MESSAGE ABOUT DINNER PLANS.” In some embodiments, the set of one or more summary criteria is based on content of message 676f and/or a length of message 676f. For example, in FIG. 6W, notification announcement 699 includes a summary of message 676f at least in part because the length of message 676f exceeds a length threshold.

In addition to the summary of message 676f, notification announcement 699 includes an option (e.g., “READ IT?”) to read the actual content of message 676f (e.g., because notification announcement 699 included a summary of message 676f instead of verbatim content of message 676f). After notification announcement 699 is output (e.g., including option “READ IT?”), user 600 performs motion input 683. Motion input 683 includes an up and down head gesture (e.g., a nod head gesture) represented by first state 683a of a head of user 600, second state 683b of the head of user 600 (e.g., which occurs after first state 683a), and third state 683c of the head of user 600 (e.g., which occurs after second state 683b). In some embodiments, motion input 683 corresponds to (e.g., is the same as and/or includes characteristics of) motion input 660 described in FIG. 6K1. In some embodiments, device 602 outputs audio 662a, audio 662b, and/or audio 662c in response to detecting first state 683a, second state 683b, and/or third state 683c, respectively (e.g., as described for motion input 660 with reference to FIG. 6K1).

In response to detection of motion input 683 and a determination that motion input 696 includes the first type of recognized head gesture and that device 602 and/or device 604 has the first configuration, device 602 outputs notification announcement 695 (e.g., “I'M TRYING TO DECIDE WHERE TO GO FOR DINNER BUT CAN'T MAKE UP MY MIND. DO YOU HAVE ANY IDEAS? REPLY?”), as shown in FIG. 6X1. Notification announcement 695 includes the verbatim content of message 676f and an option (e.g., “REPLY?”) asking whether to reply to message 676f. In some embodiments, motion input 683 must be detected within a threshold amount of time of notification announcement 699 (e.g., in accordance with a determination that less than the threshold amount of time has elapsed since output of notification announcement 699) to cause the content of message 676f to be read in response to detection of motion input 683.

After notification announcement 694 is output (e.g., including option “REPLY?”), user 600 performs motion input 697. Motion input 697 includes a side to side head gesture represented by first state 697a of the head of user 600, second state 697b of the head of user 600 (e.g., which occurs after first state 697a), and third state 697c of the head of user 600 (e.g., which occurs after second state 697b). In some embodiments, motion input 697 corresponds to (e.g., is the same as and/or includes characteristics of) motion input 664 described in FIG. 6L1. In some embodiments, device 602 outputs audio 666a, audio 666b, and/or audio 666c in response to detecting first state 697a, second state 697b, and/or third state 697c, respectively (e.g., as described for motion input 664 with reference to FIG. 6L1). In response to detection of motion input 697 and a determination that motion input 697 includes the second type of recognized head gesture and that device 602 and/or device 604 has the first configuration, device 602 and/or device 604 forgo generating and/or sending a message in response to message 676f, as illustrated by messaging user interface 676 not including a message after message 676f in FIG. 6X2. In some embodiments, motion input 697 must be detected within a threshold amount of time of notification announcement 695 (e.g., in accordance with a determination that less than the threshold amount of time has elapsed since output of notification announcement 695) to dismiss the option to reply in notification announcement 695 in response to detection of motion input 697.

FIG. 6Y illustrates device 604 displaying head gestures settings user interface 634 (e.g., as described with reference to FIGS. 6G and 6H). In FIG. 6Y, head gestures settings user interface 634 indicates the settings corresponding to the first configuration (e.g., the same configuration shown in FIG. 6H). Device 604 detects input 650n corresponding to a request to change a configuration (e.g., a configuration of head gesture settings) of device 602 and/or device 604 from the first configuration to a second configuration. In some embodiments, input 650n includes a set of one or more inputs (e.g., touch inputs and/or other selection inputs) that include selection of first head gesture configuration option 638a and/or second head gesture configuration option 638b. In response to detection of input 650n, the configuration of device 602 and/or device 604 is changed from the first configuration to the second configuration illustrated in FIG. 6Z. FIG. 6Z shows that, according to the second configuration, device 602 and/or device 604 are enabled to perform operations in response to motion inputs (e.g., as represented by the state of head gestures state option 636 being ON), a side to side head gesture corresponds to an accept operation and a reply operation (e.g., as represented by first head gesture configuration option 638a) and an up and down head gesture corresponds to a decline operation and a dismiss operation (e.g., as represented by second head gesture configuration option 638b).

FIG. 6AA1 illustrates an embodiment in which device 602 and/or device 604 are in the second configuration described with reference to FIG. 6Z. In FIG. 6AA1, device 604 receives an incoming phone call, as indicated by incoming call user interface 622 displayed on display 606 (e.g., the same incoming call described with reference to FIGS. 6D, 6N1, and/or 6O1). Incoming call user interface 622 is described above with reference to FIG. 6D1. In response to receiving the incoming phone call, device 602 outputs audio notification announcement 691 (e.g., the same notification announcement 674 described with reference to FIGS. 6N1 and/or 6O1) that there is an incoming call (e.g., “INCOMING CALL FROM KATE”). Notification announcement 691 includes an option to take an action. For example, notification announcement 691 includes an option to answer the call (e.g., “ANSWER IT?”). In some embodiments, the incoming call in FIG. 6AA1 is the same call described with reference to FIG. 6D1 and notification announcement 691 is the same notification announcement as notification announcement 624 described with reference to FIG. 6D1 and/or notification announcement 674 described with reference to FIGS. 6N1 and 6O1.

After notification announcement 691 is output, user 600 performs motion input 693, which includes an up and down head gesture represented by first state 693a of the head of user 600, second state 693b of the head of user 600 (e.g., which occurs after first state 693a), and third state 693c of the head of user 600 (e.g., which occurs after second state 693b). In some embodiments, motion input 693 corresponds to (e.g., is the same as and/or includes characteristics of) motion input 660 described in FIG. 6K1. In some embodiments, device 602 outputs audio 666a, audio 666b, and/or audio 666c in response to detecting first state 693a, second state 693b, and/or third state 693c, respectively (e.g., as described for motion input 664 with reference to FIG. 6L1, since motion input 693 corresponds to a decline and/or dismiss operation in FIG. 6AA1). In response to detection of motion input 693 and in accordance with a determination that motion input 693 includes the first type of recognized head gesture and that device 602 and/or device 604 have the second configuration, the incoming call is declined, as illustrated by display of user interface 608 displayed on device 604 in FIG. 6AA2 (e.g., dismissing the incoming call includes ceasing display of incoming call user interface 622). In some embodiments, motion input 693 must be detected within a threshold amount of time of notification announcement 691 (e.g., in accordance with a determination that less than the threshold amount of time has elapsed since output of notification announcement 691) to cause the call to be declined in response to detection of motion input 693.

FIG. 6AB1 illustrates device 604 receiving an incoming phone call (e.g., the same incoming phone call as described with reference to FIG. 6AA1), as indicated by incoming call user interface 622 displayed on display 606. Incoming call user interface 622 is described above with reference to FIG. 6D1 and FIG. 6N1. Device 602 and/or device 604 are in the second configuration described with reference to FIG. 6Z. In response to receiving the incoming phone call, device 602 outputs audio notification announcement 691 (e.g., the same notification announcement 691 described with reference to FIG. 6AA1). After notification announcement 691 is output, user 600 performs motion input 689 (e.g., instead of motion input 693 described with reference to FIG. 6AA1). Motion input 689 includes a side to side head gesture represented by first state 689a of the head of user 600, second state 689b of the head of user 600 (e.g., which occurs after first state 689a), and third state 689c of the head of user 600 (e.g., which occurs after second state 689b). In some embodiments, motion input 689 corresponds to (e.g., is the same as and/or includes characteristics of) motion input 664 described in FIG. 6L1. In some embodiments, device 602 outputs audio 662a, audio 662b, and/or audio 662c in response to detecting first state 689a, second state 689b, and/or third state 689c, respectively (e.g., as described for motion input 660 with reference to FIG. 6K1 since motion input 689 corresponds to an accept and reply operation in FIG. 6AB1). In response to detection of motion input 689 and in accordance with a determination that motion input 689 includes the second type of recognized head gesture and that device 602 and/or device 604 have the second configuration, device 604 answers and/or accepts the incoming call, as illustrated by display of active call user interface 672 displayed on device 604 in FIG. 6AB2. In some embodiments, motion input 689 must be detected within a threshold amount of time of notification announcement 691 (e.g., in accordance with a determination that less than the threshold amount of time has elapsed since output of notification announcement 691) to cause the call to be answered in response to detection of motion input 689.

FIG. 6AC1 illustrates device 604 receiving an incoming phone call (e.g., the same incoming phone call as described with reference to FIG. 6AA1 and/or FIG. 6AB1), as indicated by incoming call user interface 622 displayed on display 606. Incoming call user interface 622 is described above with reference to FIG. 6D1 and FIG. 6N1. Device 602 and/or device 604 are in the second configuration described with reference to FIG. 6Z. In response to receiving the incoming phone call, device 602 outputs audio notification announcement 691 (e.g., the same notification announcement 691 described with reference to FIG. 6AA1 and/or FIG. 6AB1).

After notification announcement 691 is output, user 600 performs motion input 687 (e.g., instead of motion input 693 described with reference to FIG. 6AA1 or motion input 689 described with referent to FIG. 6AB1). Motion input 687 is represented by first state 687a (e.g., the head of user 600 oriented up and to the right), second state 687b (e.g., the head of user 600 oriented down and to the right, which occurs after first state 687a), and third state 687c (e.g., the head of user 600 oriented to the left, which occurs after second state 687b). Notably, motion input 687 does not include motion, states, and/or poses that correspond to a type of recognized head gesture. For example, motion input 687 does not include an up and down head gesture corresponding to the first type of recognized head gesture described with reference to FIG. 6K1 and does not include a side to side head gesture corresponding to the second type of recognized head gesture described with reference to FIG. 6L1 (e.g., nor any other type of recognized head gesture in response to which device 602 and/or device 604 is configured to perform an operation). In some embodiments, because motion input 687 does not include a type of recognized head gesture, device 602 does not output feedback (e.g., audio 662a, audio 662b, audio 662c, audio 666a, audio 666b, and/or audio 666c as described for motion input 660 with reference to FIG. 6K1 and for motion input 664 with reference to FIG. 6L1) in response to first state 687a, second state 687b, and/or third state 687c. In accordance with a determination that motion input 687 does not include a type of recognized head gesture, device 602 and/or device 604 forgo performing an operation (e.g., no operation is performed) in response to detection of motion input 687, as indicated by device 604 maintaining display of call user interface 622 in the same state as shown in FIG. 6AC2.

FIG. 7 is a flow diagram illustrating a method for performing operations in response to motion inputs using a computer system in accordance with some embodiments. Method 700 is performed at a computer system (e.g., 100, 300, 500, 602, 604, a wearable device, a headset, headphones, smart headphones, one or more earbuds, one or more ear pods, an audio output device, a head-mounted device such as a head-mounted augmented reality and/or extended reality device, a smartwatch, a smartphone, a tablet computer, a desktop computer, and/or a laptop computer) that is in communication with (e.g., includes and/or is connected to) one or more input devices (e.g., 112, 206, 208, 350, 355, 504, 506, 508, 606, one or more touch-sensitive surfaces, keyboards, mice, trackpads, microphones, capacitive sensors for detecting hover inputs, and/or sensors for detecting a gaze and/or gestures such as head, hand, arm, and/or other body gestures). In some embodiments, the computer system is in communication with one or more output devices (e.g., 112, 504, 606, one or more display generation components, audio output devices, speakers, and/or tactile output devices). In some embodiments, the computer system is in communication with (e.g., includes, is connected to, and/or is in communication with another device that includes) one or more sensors (e.g., one or more detectors, motion sensors, accelerometers, gyroscopes, magnetometers, inertial measurement units, optical sensors, and/or other sensors that are capable of detecting movement of a person (such as a user of the computer system) in space). In some embodiments, the computer system is in communication with (e.g., includes and/or is connected to) one or more display generation components (e.g., one or more display controllers, touch-sensitive display systems, display screens, monitors, projectors, holographic displays, and/or head-mounted display systems). In some embodiments, the computer system is in communication with (e.g., wirelessly connected to) headphones and/or earbuds that are configured to detect a motion input. Some operations in method 700 are, optionally, combined, the orders of some operations are, optionally, changed, and some operations are, optionally, omitted.

As described below, method 700 provides an intuitive way for performing operations using motion inputs. The method reduces the cognitive burden on a user for performing operations using motion inputs, thereby creating a more efficient human-machine interface. For battery-operated computing devices, enabling a user to performing operations using motion inputs faster and more efficiently conserves power and increases the time between battery charges.

According to method 700, the computer system receives (702), via the one or more input devices (e.g., one or more sensors such as one or more motion sensors), an indication of a detection of a motion input (e.g., 670, 685, 680, 688, 692, 696, 683, 697, 693, 689, a head motion gesture, movement of a head of a person associated with the computer system, and/or movement of the computer system while the computer system is being worn on a head of a person). In some embodiments, receiving the indication of the detection of the motion input includes detecting the motion input (e.g., the computer system detects the motion input) and/or receiving data (e.g., from a device connected to the computer system) indicating that the motion input has been detected. In some embodiments, the motion input corresponds to one or more head rotations along a lateral axis (e.g., pitch rotation) indicative of a head nod gesture or one or more head rotation along a vertical axis (e.g., yaw rotation) indicative of a head shake gesture). In some embodiments, the motion input is detected based on one or more sensor measurements from one or more sensors of the computer system, a device that is connected (e.g., wirelessly and/or via a wired connection) to the computer system, and/or a device that is configured to connect (e.g., wirelessly and/or via a wired connection) to the computer system. In response (704) to receiving the indication of the detection of the motion input, the computer system performs (e.g., conditionally performs) operations 706, 708, and/or 710. In accordance with a determination that the motion input includes a first type of recognized head gesture (e.g., an up and down head gesture as shown in FIGS. 6K1, 6M1, 6N1, 6S1, 6T1, 6U, 6W, and/or 6AA1, one or more nods, one or more shakes, one or more tilts, one or more turns, one or more rolls, one or more rotations along a lateral axis, one or more rotations along a vertical axis, and/or movement of a head of a person that satisfies a first set of one or more motion criteria that are met (or not met) based on one or more characteristics of the head motion gesture, such as direction, rotation, magnitude, distance, translational velocity, angular velocity, speed, duration, and/or repetitions) and the computer system has (e.g., the computer system is set to, is operating in, and/or is operating according to) a first configuration (e.g., the configuration indicated by the settings in head gestures settings user interface 634 in FIG. 6H, a first operating configuration, a first set of operational parameters, a first state, a first settings configuration, and/or a first set of settings states and/or values), the computer system causes (706) performance of (e.g., the computer system performs and/or causes a device that is connected to the computer system to perform) a first operation (e.g., answering the incoming phone call in FIGS. 6N1-6N2, accepting the option to add a reminder in FIGS. 6S1-6S2, accepting and/or sending a predefined reply in FIGS. 6T1-6T2, accepting an option to reply to message 676d in FIGS. 6U-6V1, accepting the option to read the content of message 676f in FIGS. 6W-6X1, an audio output operation, and/or an operation associated with an alert, notification, invitation, request, application, and/or ongoing activity). In some embodiments, the first operation includes output (e.g., audio output and/or displayed output) via one or more output devices. In some embodiments, the first operation does not include output via one or more output devices (e.g., when accepting an action that does not require an output via the one or more output devices). In some embodiments, in response to receiving the indication of the detection of the motion input and in accordance with a determination that the motion input includes the first type of recognized head gesture and the computer system has the first configuration, the computer system causes performance of the first operation and forgoes causing performance of a second operation that is different from the first operation (e.g., the computer system performs the first operation without performing the second operation). In accordance with a determination that the motion input includes the first type of recognized head gesture and the computer system has (e.g., the computer system is set to, is operating in, and/or is operating according to) a second configuration (e.g., the configuration indicated by the settings shown in head gestures settings user interface 634 in FIG. 6G or FIG. 6Z, a second operating configuration, a second set of operational parameters, a second state, a second settings configuration, and/or a second set of settings states and/or values) that is different from the first configuration, the computer system forgoes (708) causing performance of (e.g., the computer system forgoes performing and/or forgoes causing a device that is connected to the computer system to perform) the first operation (e.g., as shown in FIG. 6M1 and/or FIG. 6AA1) (e.g., the computer system does not perform the first operation). In accordance with a determination that the motion input includes a second type of recognized head gesture (e.g., 664, 685, 680, 697, 689, one or more nods, one or more shakes, one or more tilts, one or more turns, one or more rolls, and/or movement of a head of a person that satisfies a second set of one or more motion criteria that are met (or not met) based on one or more characteristics of the head motion gesture, such as direction, magnitude, distance, translational velocity, angular velocity, speed, duration, and/or repetitions) that is different from the first type of recognized head gesture and the computer system has the second configuration, the computer system causes (710) performance of (e.g., the computer system performs and/or causes a device that is connected to the computer system to perform) the first operation (e.g., answering the incoming phone call in FIGS. 6AB1-6AB2). In some embodiments, in response to receiving the indication of the detection of the motion input and in accordance with a determination that the motion input includes the second type of recognized head gesture and the computer system has the second configuration, the computer system causes performance of the first operation and forgoes causing performance of the second operation (e.g., the computer system performs the first operation without performing the second operation). In some embodiments, the first operation is performed on the computer system and/or on an external device that is different from the computer system. In some embodiments, the external device is a companion device and/or a separate device that is configured to connect to and/or communicate with the computer system. In some embodiments, a companion device is a device that is paired to the computer system, logged into the same account as the computer system, configured to connect to (e.g., wirelessly connect to) and/or communicate with the computer system, configured to provide audio for output by the computer system, and/or configured to control one or more settings and/or functions of the computer system. Causing performance of an operation in response to receiving an indication of a detection of a motion input, such as a head gesture, enables the computer system to perform an operation without requiring the user to speak or physically touch a device, which allows the user to cause the computer system to perform an action discretely and with fewer mistakes, thereby reducing the number of inputs needed to perform an operation, providing additional control options without cluttering the user interface with additional displayed controls, and increasing security and/or privacy. Causing performance of a first operation in response to a first type of recognized head gesture when the computer system has a first configuration and in response to a second type of recognized head gesture when the computer system has a second configuration enables the computer system to respond in the same manner to different types of inputs under different conditions (e.g., based on the preferences of a user or the customs of a particular region), which makes it easier for a user to perform an operation with fewer mistakes, thereby reducing the number of input needed to perform an operation and providing additional control options without cluttering the user interface with additional displayed controls.

In some embodiments, in response to receiving the indication of the detection of the motion input: in accordance with a determination that the motion input includes the second type of recognized head gesture (e.g., a side to side head gesture as shown in FIG. 6O1) and the computer system has the first configuration (e.g., as shown in FIG. 6O1), performance of (e.g., the computer system performs and/or causes a device that is connected to the computer system to perform) a second operation (e.g., declining a phone call in FIG. 602, dismissing a notification as described with reference to FIGS. 6P-6Q, declining to respond to message 676f in FIGS. 6X1-6X2, an operation that includes output via one or more output devices, and/or an operation that does not include output via one or more output devices) that is different from the first operation is caused (e.g., as described with reference to FIGS. 6O1-6O2). In some embodiments, in response to receiving the indication of the detection of the motion input and in accordance with a determination that the motion input includes the second type of recognized head gesture and the computer system has the first configuration, the computer system causes performance of the second operation and forgoes causing performance of the first operation (e.g., the computer system performs the second operation without performing the first operation). In some embodiments, the second operation is performed on the computer system and/or on an external device that is different from the computer system (e.g., the external device is a companion device and/or a separate device that is configured to connect to and/or communicate with the computer system). Causing performance of a second operation in accordance with a determination that the motion input includes the second type of recognized head gesture and the computer system has the first configuration enables the computer system to cause performance of different operations by distinguishing between different types of inputs, which allows the user to cause the computer system to perform multiple action discretely and with fewer mistakes, thereby reducing the number of inputs needed to perform an operation, performing an operation when a set of conditions has been met without requiring further user input, providing additional control options without cluttering the user interface with additional displayed controls, and increasing security and/or privacy.

In some embodiments, the second operation includes responding to a notification (e.g., 674 and/or 691) by declining to take (e.g., forgoing taking, not taking, and/or without taking) an action associated with the notification (e.g., declining to answer a phone call that initiated the notification) (e.g., declining the call in FIG. 6O1 in response to notification announcement 674 and/or declining the call in FIG. 6AA1 in response to notification announcement 691). Causing a device to respond to a notification by declining to take an action associated with a notification in response to a motion input enables the computer system to dismiss and/or stop an action associated with the notification without requiring the user to speak or physically touch a device, which allows the user to cause the computer system to perform an action quickly, discretely, and with fewer mistakes, thereby reducing the number of inputs needed to perform an operation and increasing security and/or privacy. In some embodiments, the second operation includes causing, without performing another operation, at least a portion (e.g., 678b) of an audio output (e.g., 678) associated with the notification to not be performed (e.g., as in FIGS. 6P-6Q) (e.g., declining a phone call, requesting that at least a portion of an audio notification not be output, and/or requesting that output of an audio notification stop). For example, in some embodiments, the second operation includes stopping a notification (e.g., an announcement) from being read (e.g., prior to the notification being read or while the notification is being read). Causing at least a portion of an audio output associated with a notification to not be performed enables the computer system to avoid outputting audio when the audio is not desired by the user or would be distracting to the user without requiring the user to speak or physically touch a device, which allows the user to cause the computer system to perform an action discretely and with fewer mistakes, thereby reducing the number of inputs needed to perform an operation, providing additional control options without cluttering the user interface with additional displayed controls, and increasing security and/or privacy. In some embodiments, causing the portion (e.g., 678b) of the audio output associated with the notification to not be performed includes (e.g., while the audio output associated with the notification is being performed) causing the audio output (e.g., 678) associated with the notification to stop being performed before the portion of the audio output associated with the notification is output (e.g., as in FIGS. 6P-6Q) (e.g., stopping and/or silencing an audio notification of an incoming call during the audio notification and/or while the computer system is ringing due to the incoming call). Causing the portion of the audio output associated with the notification to stop being performed enables the computer system to stop outputting audio when the audio is not desired by the user or would be distracting to the user without requiring the user to speak or physically touch a device, which allows the user to cause the computer system to perform an action discretely and with fewer mistakes, thereby reducing the number of inputs needed to perform an operation, providing additional control options without cluttering the user interface with additional displayed controls, and increasing security and/or privacy.

In some embodiments, the second operation includes: after declining to take the action associated with the notification (e.g., declining the call in FIG. 6O1), outputting (e.g., automatically, without receiving further input) a set of one or more selectable options (e.g., outputting an option to send a message or initiate a call to the caller (e.g., “KATE”) in FIG. 6O1) corresponding to respective operations associated with the notification (e.g., sending a message corresponding to a declined incoming call, such as a message to a caller of a call corresponding to the notification, and/or sending a text message to a text thread after silencing an announcement of a message received in the thread). In some embodiments, outputting the set of one or more selectable options includes displaying a selectable graphical element and/or outputting an audible option (e.g., outputting audio describing an option). In some embodiments, the set of one or more selectable options is output (e.g., displayed and/or otherwise provided) at the computer system and/or at an external device that is different from the computer system (e.g., the external device is a companion device and/or a separate device that is configured to connect to and/or communicate with the computer system). Outputting a set of one or more selectable options corresponding to respective operations associated with a notification enables the computer system to respond to a notification without requiring the user to speak or physically touch a device, which allows the user to cause the computer system to perform an action discretely and with fewer mistakes, thereby reducing the number of inputs needed to perform an operation, providing additional control options without cluttering the user interface with additional displayed controls, and increasing security and/or privacy.

In some embodiments, after outputting the set of one or more selectable options (e.g., while the set of one or more selectable options are displayed and/or available to be selected): in accordance with a determination that an input (e.g., an up and down head gesture, a touch input, a voice input, an air gesture, and/or a body gesture) corresponding to selection of a first option (e.g., an option to send a message or initiate a call to the caller (e.g., “KATE”) in FIG. 6O1) of the set of one or more selectable options has been detected (e.g., via the one or more input devices), performance of an operation corresponding to the first option is caused. In some embodiments, the input corresponding to selection of the first option includes a voice command (e.g., saying “yes”) and/or a head motion (e.g., nodding). In some embodiments, the operation corresponding to the first option is performed on the computer system and/or on an external device that is different from the computer system (e.g., the external device is a companion device and/or a separate device that is configured to connect to and/or communicate with the computer system). Causing performance of an operation corresponding to a selected option enables the computer system to respond to a notification without requiring the user to speak or physically touch a device, which allows the user to cause the computer system to perform an action discretely and with fewer mistakes, thereby reducing the number of inputs needed to perform an operation, providing additional control options without cluttering the user interface with additional displayed controls, and increasing security and/or privacy. In some embodiments, after outputting the set of one or more selectable options (e.g., “REPLY?” like in FIG. 6U and/or FIG. 6X1) (e.g., while the set of one or more selectable options are displayed and/or available to be selected): in accordance with a determination that a set of one or more criteria associated with the set of one or more selectable options is satisfied (e.g., detection of motion input 697 and/or no motion input like in FIG. 6R) (e.g., an input corresponding to selection of an option of the set of one or more selectable options has not been detected, an input corresponding to a request to decline selecting any of the one or more selectable options, and/or an input corresponding to a request to decline performing any of the operations corresponding to the set of one or more selectable options), the computer system forgoes causing performance of the operation corresponding to the first option (and, in some embodiments, forgoing causing performance of an operation corresponding to any of the set of one or more selectable options and/or forgoing causing selection of any of the set of one or more selectable options) (e.g., not sending a reply as in FIGS. 6X1-6X2). Forgoing causing performance of an operation if conditions associated with the options are not satisfied (e.g., an option for performing the operation is not selected) enables the computer system to forgo undesired or unnecessary operations without requiring the user to speak or physically touch a device, which allows the user to cause the computer system to operate discretely and with fewer mistakes, thereby reducing the number of inputs needed to perform an operation, providing additional control options without cluttering the user interface with additional displayed controls, and increasing security and/or privacy.

In some embodiments, in accordance with a determination that a head gesture configuration setting (e.g., the setting corresponding to head gestures state option 636, first head gesture configuration option 638a, and/or second head gesture configuration option 638b, a user-selectable setting, a setting that determines whether the computer system is enabled to respond to a head gesture, and/or a setting that determines a manner in which the computer system responds to a head gesture) is in a first configuration state (e.g., 636 is set to on, 638a is set to up and down, and/or 638b is set to side to side, as illustrated in FIG. 6H), the computer system is determined to have the first configuration (e.g., a determination that the computer system has the first configuration includes a determination that the head gesture configuration setting is in the first configuration state); and in accordance with a determination that the head gesture configuration setting is in a second configuration state (e.g., 636 is set to off as in FIG. 6G and/or 636 is set to off, 638a is set to side to side, and/or 638b is set to up and down, as illustrated in FIG. 6Z) that is different from the first configuration state, the computer system is determined to have the second configuration (e.g., a determination that the computer system has the second configuration includes a determination that the head gesture configuration setting is in the second configuration state). For example, the configuration of the computer system is based on the head gesture configuration setting. In some embodiments, while the head gesture configuration setting is in the first configuration state, a first operation is performed in response to receiving an indication of detection of a first motion input that includes the first type of recognized head gesture and in accordance with a determination that the head gesture configuration setting is in the first configuration state; after performing the first operation, the head gesture configuration setting is changed to the second configuration state in response to detection of a set of one or more inputs corresponding to a request to change the head gesture configuration setting to the second configuration state; after the head gesture configuration setting is changed to the second configuration state (and while the head gesture configuration setting is in the second configuration state), a second operation that is different from the first operation is performed in response to receiving an indication of detection of a second motion input that includes the first type of recognized head gesture (that is different from the first motion input that includes the first type of recognized head gesture) and in accordance with a determination that the head gesture configuration setting is in the second configuration state (e.g., a different operation is performed in response to detection of the same type of recognized head gesture because the head gesture configuration setting has been changed to a different state). In some embodiments, the head gesture configuration setting is changed in response to detection of a set of one or more inputs at an external device that is different from the computer system (e.g., the computer system is a pair of headphones, and the external device is a smartphone, laptop computer, tablet computer, and/or desktop computer). In some embodiments, the external device includes a companion device. Determining the configuration of the computer system based on a state of a head gesture configuration setting enables the computer system to perform operations in response to motion inputs based on a user-configurable setting, which makes the computer system more customizable and reduces user mistakes, thereby performing an operation when a set of conditions has been met without requiring further user input and reducing the number of inputs needed to perform an operation.

In some embodiments, the first type of recognized head gesture includes one or more head movements (e.g., movements and/or rotations back and forth along a lateral axis, such as a pitch rotation) indicative of a head nod gesture (e.g., an up and down head gesture described in FIG. 6K1). Performing an operation in response to a head nod gesture enables the computer system to perform an operation without requiring the user to speak or physically touch a device, which allows the user to cause the computer system to perform an action discretely and with fewer mistakes, thereby reducing the number of inputs needed to perform an operation, providing additional control options without cluttering the user interface with additional displayed controls, and increasing security and/or privacy. In some embodiments, the second type of recognized head gesture includes one or more head movements (e.g., movements and/or rotations back and forth along a vertical axis, such as a yaw rotation) indicative of a head shake gesture (e.g., a side to side head gesture described in FIG. 6L1). Performing an operation in response to a head shake gesture enables the computer system to perform an operation without requiring the user to speak or physically touch a device, which allows the user to cause the computer system to perform an action discretely and with fewer mistakes, thereby reducing the number of inputs needed to perform an operation, providing additional control options without cluttering the user interface with additional displayed controls, and increasing security and/or privacy.

In some embodiments, the detection of the motion input is performed with one or more wearable headphones (e.g., with device 602 and/or using one or more motion sensors of the wearable headphones, such as accelerometers, gyroscopes, inertial measurement units, and/or magnetometers). In some embodiments, the computer system includes the one or more wearable headphones. In some embodiments, the computer system is connected to (e.g., wirelessly connected to) the one or more wearable headphones. Detecting the motion input using one or more wearable headphones enables the computer system to perform an operation in response to head motions without requiring the user to speak or physically touch a device, which allows the user to cause the computer system to perform an action discretely and with fewer mistakes, thereby reducing the number of inputs needed to perform an operation, providing additional control options without cluttering the user interface with additional displayed controls, and increasing security and/or privacy. In some embodiments, the one or more wearable headphones include a pair of wearable headphones (e.g., 602 and/or a first wearable headphone and a second wearable headphone), and in response to receiving the indication of the detection of the motion input: in accordance with a determination that a set of one or more error criteria is satisfied (e.g., as described with reference to FIG. 6I), the set of one or more error criteria including a first criterion that is satisfied when the motion input includes a respective type of recognized head gesture (e.g., the first type of recognized head gesture and/or the second type of recognized head gesture) and a second criterion that is satisfied when only one of the pair of wearable headphones is being worn (e.g., at a time that the motion input is determined to include the respective type of recognized head gesture), causing output (e.g., display, audio output, and/or tactile output) of an indication (e.g., 642, a visual indication, such as a graphical element, an audible indication, and/or a tactile indication) that an error has occurred. In some embodiments, the indication that the error has occurred is output at the computer system and/or at an external device that is different from the computer system (e.g., the external device is a companion device and/or a separate device that is configured to connect to and/or communicate with the computer system). For example, if the computer system is a device that does not have a display (e.g., such as a pair of headphones), the indication is displayed on a companion device that includes a display). Causing output of an indication that an error had occurred when the set of one or more error criteria is satisfied enables the computer system to alert a user when the computer system may have reduced ability to respond correctly to a motion input, which allows the computer system to operate with fewer user mistakes, thereby providing improved feedback to the user, performing an operation when a set of conditions has been met without requiring further user input, and reducing the number of inputs needed to perform an operation.

In some embodiments, in accordance with a determination that a language setting (e.g., a language setting of device 604, a language setting accessible by selecting settings icon 628, a user-selectable setting and/or a setting that determines a language in which the computer system displays content and/or outputs audio content) is in a first language state (e.g., corresponding to a first language), the computer system is determined to have the first configuration (e.g., a determination that the computer system has the first configuration includes a determination that the language setting is in the first language state); and in accordance with a determination that the language setting is in a second language state that is different from the first language state (e.g., the second language state corresponds to a second language that is different from the first language), the computer system is determined to have the second configuration (e.g., a determination that the computer system has the second configuration includes a determination that the language setting is in the second language state). For example, the configuration of the computer system is based on the language setting. In some embodiments, the language setting is a language setting on the computer system and/or a language setting on an external device that is different from the computer system (e.g., the external device is a companion device and/or a separate device that is configured to connect to and/or communicate with the computer system). Determining the configuration of the computer system based on a state of a language setting enables the computer system to perform operations in response to motion inputs based on conventions associated with a particular language, which makes the computer system more customizable and reduces user mistakes, thereby performing an operation when a set of conditions has been met without requiring further user input and reducing the number of inputs needed to perform an operation.

In some embodiments, in accordance with a determination that a region setting (e.g., a region setting of device 604, a region setting accessible by selecting settings icon 628, a user-selectable setting and/or a setting that causes the computer system to operate according to characteristics, such as time, location, and/or language, of a particular geographic region) is in a first region state (e.g., corresponding to a first region), the computer system is determined to have the first configuration (e.g., a determination that the computer system has the first configuration includes a determination that the region setting is in the first region state); and in accordance with a determination that the region setting is in a second region state that is different from the first region state (e.g., the second region state corresponds to a second region that is different from the first region), the computer system is determined to have the second configuration (e.g., a determination that the computer system has the second configuration includes a determination that the region setting is in the second region state). For example, the configuration of the computer system is based on the region setting. In some embodiments, the region setting is a region setting on the computer system and/or a region setting on an external device that is different from the computer system (e.g., the external device is a companion device and/or a separate device that is configured to connect to and/or communicate with the computer system). Determining the configuration of the computer system based on a state of a region setting enables the computer system to perform operations in response to motion inputs based on conventions associated with a particular region, which makes the computer system more customizable and reduces user mistakes, thereby performing an operation when a set of conditions has been met without requiring further user input and reducing the number of inputs needed to perform an operation.

In some embodiments, the detection of the motion input occurs within a threshold amount of time of a notification (e.g., 674, 678, 690, 694, 699, 695, 691, a notification that can be responded to using a motion input). For example, the motion input is performed in response to a particular type of notification. In some embodiments, the computer system causes performance of an operation in response to receiving the indication of the detection of the motion input in accordance with a determination that (e.g., only if) less than a threshold amount of time has elapsed since a notification that can be responded to using the motion input has occurred. In some embodiments, in response to receiving the indication of the detection of the motion input: in accordance with a determination that a set of one or more notification criteria is not satisfied (e.g., more than a threshold amount of time has elapsed since a notification that can be responded to using a head gesture occurred), the computer system forgoes causing performance of an operation corresponding to the motion input (e.g., the motion input is ignored if the motion input does not occur within the threshold amount of time of a notification that can be responded to using the motion input). In some embodiments, the threshold amount of time of the notification is a threshold amount of time after the notification starts or a threshold amount of time after the notification ends. Performing an operation in response to a motion input that occurs within a threshold amount of time of a notification enables the computer system to respond to a notification without requiring the user to speak or physically touch a device and to avoid inadvertently performing an operation in response to a motion input when a response is not desired based on the context, which allows the computer system to be operated discretely and with fewer mistakes, thereby reducing the number of inputs needed to perform an operation, providing additional control options without cluttering the user interface with additional displayed controls, and increasing security and/or privacy. In some embodiments, the notification includes an audio notification (e.g., a sound, a sequence of sounds, and/or simulated verbal output). Performing an operation in response to a motion input that occurs within a threshold amount of time of an audio notification enables the computer system to respond to an audio notification without requiring the user to speak or physically touch a device and to avoid inadvertently performing an operation in response to a motion input when a response is not desired based on the context, which allows the computer system to be operated discretely and with fewer mistakes, thereby reducing the number of inputs needed to perform an operation, providing additional control options without cluttering the user interface with additional displayed controls, and increasing security and/or privacy.

In some embodiments, in response to receiving the indication of the detection of the motion input: prior to causing performance of an operation in accordance with a determination that the motion input includes a respective type of recognized head gesture (and, in some embodiments, in accordance with a determination that the computer system has a respective configuration), a first output (e.g., 662a, 662b, 666a, 666b, an audio output, tactile output, visual output, and/or feedback indicating a beginning of the motion input) via one or more output devices (e.g., of the computer system and/or an external device in communication with and/or connected to the computer system) is caused. In some embodiments, the first output occurs on the computer system and/or on an external device that is different from the computer system (e.g., the external device is a companion device and/or a separate device that is configured to connect to and/or communicate with the computer system). Causing output in response to detection of the motion input prior to causing performance of an operation provides the user with information that the motion input is being recognized so that the user can determine whether to continue the motion input to cause the operation, which allows the computer system to be operated with fewer mistakes, thereby providing improved feedback to the user and reducing the number of inputs needed to perform an operation. In some embodiments, in response to receiving the indication of the detection of the motion input: after causing the first output and in accordance with a determination that the motion input includes a respective type of recognized head gesture (e.g., after the motion input has ended), a second output (e.g., 662c, 666c, an audio output, tactile output, visual output, and/or feedback indicating that the motion input has been recognized) via the one or more output devices is caused. In some embodiments, the second output occurs on the computer system and/or on an external device that is different from the computer system (e.g., the external device is a companion device and/or a separate device that is configured to connect to and/or communicate with the computer system). Causing output when the motion input is determined to include a respective type of recognized head gesture alerts the user that a head gesture has been recognized and allows the computer system to be operated with fewer mistakes, thereby providing improved feedback to the user and reducing the number of inputs needed to perform an operation.

In some embodiments, in response to receiving the indication of the detection of the motion input: prior to causing performance of an operation in accordance with a determination that the motion input includes a respective type of recognized head gesture (e.g., the first type of recognized head gesture and/or the second type of recognized head gesture): in accordance with a determination that a progress setting (e.g., a progress setting of 602, a progress setting of 604, a progress setting in 630, the setting corresponding to 636, the head gesture configuration setting, and/or a motion input progress feedback setting) is in a first state (e.g., on, activated, and/or enabled), a first output (e.g., 662a, 662b, 662c, 666a, 666b, 666c, an audio output, visual output, and/or feedback indicating a beginning of the motion input) via one or more output devices (e.g., of the computer system and/or an external device in communication with and/or connected to the computer system) is caused; and in accordance with a determination that the progress setting (e.g., the head gesture configuration setting) is in a second state (e.g., off, deactivated, and/or disabled) that is different from the first state, the computer system forgoes causing the first output (e.g., an audio and/or visual output) via the one or more output devices. For example, the computer system provides feedback about the progress of the motion input when the progress setting is enabled and does not provide feedback about the progress of the motion input when the progress setting is disabled. In some embodiments, the progress setting is a progress setting on the computer system and/or a progress setting on an external device that is different from the computer system (e.g., the external device is a companion device and/or a separate device that is configured to connect to and/or communicate with the computer system). Causing output or forgoing causing output in response to a motion input based on a state of a progress setting increases the customization of the computer system and enables the computer system to be operated with fewer user mistakes, thereby providing improved feedback to the user, performing an operation when a set of conditions has been met without requiring further user input and reducing the number of inputs needed to perform and operation.

In some embodiments, the first operation includes answering a call (e.g., a phone call, a video call, and/or a real-time communication session) (e.g., as in FIGS. 6N1-6N2 and/or 6AB1-6AB2). For example, the computer system causes a phone call to be answered in response to the motion input. Answering a call in response to receiving an indication of a detection of a motion input, such as a head gesture, enables the computer system to answer a call without requiring the user to speak or physically touch a device, which allows the user to answer a call discretely and with fewer mistakes, thereby reducing the number of inputs needed to perform an operation, providing additional control options without cluttering the user interface with additional displayed controls, and increasing security and/or privacy.

In some embodiments, the first operation includes a recommended operation (e.g., “ANSWER IT?” in FIGS. 6N1 and/or 6AB1, “ADD A REMINDER?” in FIG. 6S1, “REPLY WITH ES20?” in FIG. 6T1, and/or “REPLY?” in FIG. 6U) that is presented (e.g., suggested, recommended, displayed, and/or played) to the user (e.g., in a notification, alert, and/or announcement). In some embodiments, the computer system causes an operation to be recommended to a user by causing an option corresponding to the operation to be presented (e.g., displayed and/or output) to the user. In some embodiments, the option corresponding to the operation is presented based on context and/or content of a received message. Performing an operation that is presented to a user in response to receiving an indication of a detection of a motion input, such as a head gesture, enables the computer system to provide a recommended operation to a user and respond to a user's selection of a presented option without requiring the user to speak or physically touch a device, which allows the user to operate the computer system discretely and with fewer mistakes, thereby reducing the number of inputs needed to perform an operation, providing additional control options without cluttering the user interface with additional displayed controls, and increasing security and/or privacy. In some embodiments, the recommended operation includes creating a reminder (e.g., scheduling an output of a notification of an upcoming event, such as a calendar event) (e.g., as shown in FIG. 6S2). In some embodiments, creating the reminder is performed on the computer system and/or on an external device that is different from the computer system (e.g., the external device creates the reminder). In some embodiments, the external device is a companion device and/or a separate device that is configured to connect to and/or communicate with the computer system. Creating a reminder in response to receiving an indication of a detection of a motion input, such as a head gesture, enables the computer system to create a reminder without requiring the user to speak or physically touch a device, which allows the user to create a reminder discretely and with fewer mistakes, thereby reducing the number of inputs needed to perform an operation, providing additional control options without cluttering the user interface with additional displayed controls, and increasing security and/or privacy. In some embodiments, the recommended operation includes responding to a message (e.g., generating and/or sending a reply to a message, such as a text message, instant message, email message, phone message, and/or video message) (e.g., as shown in FIGS. 6T1-6T2 and/or 6U-6V2). In some embodiments, responding to the message is performed on the computer system and/or on an external device that is different from the computer system (e.g., the external device responds to the message). In some embodiments, the external device is a companion device and/or a separate device that is configured to connect to and/or communicate with the computer system. Responding to a message in response to receiving an indication of a detection of a motion input, such as a head gesture, enables the computer system to create respond to a message without requiring the user to speak or physically touch a device, which allows the user to respond to a message discretely and with fewer mistakes, thereby reducing the number of inputs needed to perform an operation, providing additional control options without cluttering the user interface with additional displayed controls, and increasing security and/or privacy.

In some embodiments, responding to the message (e.g., 676b and/or 686d) includes generating a response (e.g., 676e, a message, and/or a user-generated response) with content that is based on a user input (e.g., 698, a touch input, a voice input, an air gesture, and/or a body gesture) and sending the response (e.g., as shown in FIGS. 6V1-6V2). In some embodiments, generating the response includes generating the content of the response based on verbal dictation by a user. In some embodiments, generating the response is performed on the computer system and/or on an external device that is different from the computer system (e.g., in some embodiments, the external device generates the response). In some embodiments, the external device is a companion device and/or a separate device that is configured to connect to and/or communicate with the computer system. Generating and sending a response with content that is based on user input enables the computer system to create a response that is customized by the user and for the computer system to be operated with fewer mistakes, thereby providing improved feedback to the user and reducing the number of inputs needed to perform an operation.

In some embodiments, responding to the message (e.g., 676b) includes sending a predefined response (e.g., 676c, a suggested response, a canned response, a response that is generated without user input and/or a request by the user, and/or a response that is presented by the computer system to the user and can be selected by the user) (e.g., as shown in FIGS. 6T1-6T2). In some embodiments, the computer system provides (e.g., displays and/or outputs) one or more options (e.g., graphical options and/or audio options) corresponding to respective predefined responses that can be selected by a user and sent (e.g., in response to one or more motion inputs). In some embodiments, sending the predefined response is performed on the computer system and/or on an external device that is different from the computer system (e.g., in some embodiments, the external device sends the predefined response). In some embodiments, the external device is a companion device and/or a separate device that is configured to connect to and/or communicate with the computer system. Sending a predefined response enables the computer system to provide a suggested response and respond to a message or notification with fewer user inputs, which allows the computer system to be operated with fewer mistakes, thereby providing improved feedback to the user and reducing the number of inputs needed to perform an operation. In some embodiments, sending the predefined response includes sending a response that is a confirmation (e.g., yes, received, okay, sounds good, and/or an affirmative response) to the message (or, in some embodiments, content of the message). In some embodiments, sending the response that is a confirmation to the message is performed on the computer system and/or on an external device that is different from the computer system (e.g., in some embodiments, the external device sends the response that is the confirmation to the message). In some embodiments, the external device is a companion device and/or a separate device that is configured to connect to and/or communicate with the computer system. Sending a confirmation response enables the computer system to send a confirmation (e.g., to a prompt) with fewer user inputs, which allows the computer system to be operated with fewer mistakes, thereby providing improved feedback to the user and reducing the number of inputs needed to perform an operation. In some embodiments, the predefined response (e.g., 676c) includes content (e.g., contextually relevant content) that is based on information associated with a user of the computer system and that is available to the computer system (e.g., a calendar event, a meeting, a contact, contact information, and/or flight and/or travel information). In some embodiments, the computer system generates one or more predefined responses based on information associated with a user of the computer system and that is available to the computer system and presents the one or more predefined responses for selection by a user (e.g., via one or more motion inputs). In some embodiments, the information associated with the user of the computer system includes information from the computer system and/or information from an external device that is different from the computer system (e.g., the external device is a companion device and/or a separate device that is configured to connect to and/or communicate with the computer system). Sending a predefined response that includes content that is based on information associated with a user of the computer system enables the computer system to send a response that is contextually relevant to the user and with fewer user inputs, which allows the computer system to be operated with fewer mistakes, thereby providing improved feedback to the user and reducing the number of inputs needed to perform an operation.

In some embodiments, the first operation includes outputting (e.g., reading and/or audibly outputting) content of a notification (e.g., content of message 676f in notification 695, reading additional content of a notification, and/or continuing to output content of the notification) (e.g., as in FIG. 6X1). In some embodiments, the notification is from an external device that is different from the computer system (e.g., the external device is a companion device and/or a separate device that is configured to connect to and/or communicate with the computer system). Outputting content of a notification in response to receiving an indication of a detection of a motion input, such as a head gesture, enables the computer system to present a notification to a user without requiring the user to speak or physically touch a device, which allows the user to cause the computer system to output the content of the notification discretely and with fewer mistakes, thereby reducing the number of inputs needed to perform an operation, providing additional control options without cluttering the user interface with additional displayed controls, and increasing security and/or privacy. In some embodiments, prior to receiving the indication of the detection of the motion input (e.g., 683), audio of a summary (e.g., “KATE SENT A MESSAGE ABOUT DINNER PLANS” in 699) of content of a notification (e.g., a summary of the content of the notification) is output (e.g., by the computer system and/or a device that is in communication with the computer system, such as a companion device). In some embodiments, the computer system causes the output of the audio of the summary of the content of the notification. In some embodiments, the summary includes content that is not included in the notification (e.g., at least a portion of the summary is generated automatically). Outputting content of a notification in response to a motion input after output of a summary of the content of the notification enables the computer system to limit the content provided to the user until the user affirmatively requests the content of the notification, thereby providing improved feedback to the user and increasing security and/or privacy.

In some embodiments, prior to receiving the indication of the detection of the motion input (e.g., 680), audio of a portion (e.g., 678a) of content of a notification (e.g., verbatim audio of the portion of the content) is output (e.g., by the computer system and/or a device that is in communication with the computer system) (e.g., as in FIG. 6P). In some embodiments, the computer system causes the output of the audio of the portion of the content of the notification. Outputting audio of a portion of content of a notification prior to receiving the indication of the detection of the motion input enables the computer system to notify the user without requiring input from the user, thereby providing improved feedback to the user and reducing the number of inputs needed to perform an operation.

In some embodiments, in response to receiving the indication of the detection of the motion input: in accordance with a determination that a motion input control setting is disabled (e.g., 636 is off in FIG. 6G), the computer system forgoes causing performance of an operation (e.g., the first operation and/or the second operation) based on the motion input (e.g., as in FIGS. 6M1-6M2). In some embodiments, the motion input control setting is enabled and/or disabled in response to detection of a set of one or more inputs (e.g., by the computer system and/or a device that is in communication with the computer system). In some embodiments, the computer system causes performance of the first operation in accordance with a determination that the motion input control setting is enabled. In some embodiments, the motion input control setting is a motion input control setting on the computer system and/or a motion input control setting on an external device that is different from the computer system (e.g., the external device is a companion device and/or a separate device that is configured to connect to and/or communicate with the computer system). Forgoing causing performance of an operation based on the motion input in accordance with a determination that a motion input control setting is disabled enables the computer system to be customized by a user, which reduces user mistakes and undesired responses, thereby providing improved feedback to the user, performing an operation when a set of conditions has been met without requiring further user input, and reducing the number of inputs needed to perform an operation.

In some embodiments, in accordance with a determination (or, in some embodiments, in response to detecting) that a connection (e.g., 601) has been established between the computer system and an external computer system (e.g., between 602 and 604, between the computer system and a set of headphones, and/or between the computer system and a smartphone, tablet computer, laptop computer, smartwatch, and/or desktop computer), a user interface element (or, in some embodiments, a set of one or more user interface elements) (e.g., 614 and/or 620) for enabling the computer system to perform operations in response to motion inputs is displayed (e.g., on the computer system and/or on the external computer system); an input (e.g., 650b, 650c, a touch input, a voice input, an air gesture, and/or a body gesture) corresponding to selection of the user interface element (or, in some embodiments, a set of one or more inputs corresponding to selection of the set of one or more user interface elements) for enabling the computer system to perform operations in response to motion inputs (e.g., motion inputs that include one or more types of recognized head gestures) is detected (e.g., on the computer system and/or on the external computer system); and in response to detection of the input corresponding to selection of the user interface element for enabling the computer system to perform operations in response to motion inputs, the computer system is enabled to cause performance of operations (e.g., the first operation and/or the second operation) in response to motion inputs (e.g., device 602 and/or device 604 is enabled to cause performance of operations and/or 636 is set to on in response to motion inputs in response to selection of 620). In some embodiments, motion inputs are not detected and/or the indication of the detection of the motion input is not received when the computer system is not enabled to cause performance of operations in response to motion inputs. In some embodiments, the computer system causes performance of an operation (e.g., the first operation and/or the second operation) in accordance with a determination that the computer system is enabled to cause performance of operations in response to motion inputs and forgoes causing performance of the operation in accordance with a determination that the computer system is not enabled to cause performance of operations in response to motion inputs. In some embodiments, establishing a connection between the computer system and the external computer system includes an initial pairing between the computer system and the external computer system and/or determining that a software update has been performed on the computer system and/or the external computer system since the computer system was last used. Displaying a user interface element for enabling the computer system to cause performance of operations in response to motion inputs in accordance with a determination that a connection has been established between the computer system and an external computer system notifies the user of the ability of the computer system to cause performance of operations in response to motion inputs and allows the user to enable the feature without requiring additional inputs to navigate the user interface, thereby providing improved feedback to the user, performing an operation when a set of conditions has been met without requiring further user input, and reducing the number of inputs needed to perform an operation.

In some embodiments, a tutorial (e.g., 646a, 646b, and/or 646c) is provided (e.g., at the computer system and/or at an external computer system that is connected to the computer system), wherein providing the tutorial includes: causing display of (e.g., via the one or more display generation components in communication with the computer system or via one or more display generation components of the external computer system that is connected to the computer system) a user interface (e.g., 646b and/or 646c) that includes instructions (e.g., 656a, 656b, 656e, and/or 656f) for performing the first type of recognized head gesture (e.g., up and down) and the second type of recognized head gesture (e.g., side to side); and causing output (e.g., at the computer system and/or at the external computer system that is connected to the computer system) of audio feedback (e.g., 662a-662c and/or 666a-666c) in response to motion inputs (e.g., 660 and/or 664) detected while the instructions for performing the first type of recognized head gesture and the second type of recognized head gesture are displayed. In some embodiments, the external computer system that is connected to the computer system includes a companion device to the computer system, a device that is paired with the computer system, and/or a device that includes a two-way communication link (e.g., via Bluetooth and/or Wi-Fi) with the computer system, such as a smartphone, tablet computer, laptop computer, and/or desktop computer. Providing a tutorial that includes instructions for performing the first type of recognized head gesture and the second type of recognized head gesture enables the computer system to teach the user how to activate operations using head gestures, which reduces user mistakes and allows the computer system to be used more efficiently, which reduces the number of inputs needed to perform an operation. Causing output of audio feedback in response to motion inputs detected while the instructions for performing the first type of recognized head gesture and the second type of recognized head gesture are displayed informs the user that a head gesture has been properly performed and/or recognized, thereby providing improved feedback to the user. In some embodiments, providing the tutorial includes: causing display of instructions (e.g., 656a, 656b, visual instructions, and/or audible instructions) for a user to perform the first type of recognized head gesture; and after (e.g., in response to) receiving an indication that a motion input (e.g., 660) that includes the first type of recognized head gesture has been detected (e.g., after or while displaying the instructions for a user to perform the first type of recognized head gesture), causing output of a prompt (e.g., 656d, 654, enabling of 654, a visual and/or audible prompt, instructions, and/or a selectable graphical user interface element such as a selectable icon, button, and/or affordance) to continue the tutorial (e.g., to provide instructions to perform the second type of recognized head gesture). In some embodiments, in response to receiving an indication that a motion input that includes the first type of recognized head gesture has been detected, an option for continuing the tutorial is provided (e.g., at the computer system and/or at an external computer system such as a companion device); and in response to selection of the option for continuing the tutorial, the instructions for a user to perform the second type of recognized head gesture are displayed (e.g., at the computer system and/or at an external computer system such as a companion device). Causing output of a prompt to continue the tutorial after receiving an indication that a motion input that includes the first type of recognized head gesture has been detected informs the user that a subsequent stage of the tutorial is available and provides the user with an option to continue the tutorial without requiring additional input, thereby providing improved feedback to the user and reducing the number of inputs needed to perform an operation. In some embodiments, causing output of the prompt (e.g., 656d, 654, and/or enabling of 654) to continue the tutorial is performed in response to receiving the indication that the motion input (e.g., 660) that includes the first type of recognized head gesture has been detected; causing output of the prompt to continue the tutorial includes causing output (e.g., graphical output, tactile output, and/or audible output via one or more output devices of the computer system and/or an external device in communication with and/or connected to the computer system) of an option (e.g., 654, 654 in a selectable state, a selectable element, a graphical element, a button, an icon, an affordance, and/or a user-interactive element) to provide instructions (e.g., 656e and/or 656f) for the user to perform the second type of recognized head gesture; an input (e.g., 650k, a touch input, a voice input, an air gesture, and/or a body gesture) corresponding to selection of the option (e.g., 654) to provide instructions for the user to perform the second type of recognized head gesture is detected (e.g., at the computer system and/or at an external computer system such as a companion device); and in response to detection of the input corresponding to selection of the option to provide instructions for the user to perform the second type of recognized head gesture, causing output of (e.g., displaying and/or providing) instructions (e.g., 656e and/or 656f) for the user to perform the second type of recognized head gesture are output (e.g., displayed and/or provided at the computer system and/or at an external computer system such as a companion device). In some embodiments, while the instructions for the user to perform the second type of recognized head gesture are being output, the computer system receives (e.g., detects and/or receives from an external device) an indication that a motion input that includes the second type of recognized head gesture has been detected; and in response to receiving the indication that a motion input that includes the second type of recognized head gesture has been detected, the computer system, causes output (e.g., at the computer system and/or at the external computer system that is connected to the computer system) audio feedback that the second type of recognized head gesture has been detected. Providing a selectable option to provide instructions to perform the second type of recognized head gesture informs the user that a subsequent stage of the tutorial is available and provides the user with an easily selectable option to continue the tutorial, thereby providing improved feedback to the user and reducing the number of inputs needed to perform an operation.

In some embodiments, the computer system receives, via the one or more input devices, an indication of a detection of a physical press input (e.g., at the computer system and/or at an external device connected to the computer system) (e.g., detection of 650p and/or 650q); and in response to receiving the indication of the detection of the physical press input: in accordance with a determination that the physical press input is a first type of physical press input (e.g., a single press and/or an input that satisfies a first set of input criteria), the computer system causes performance of the first operation (e.g., read a message, reply to a message, take an action, confirm a request to a virtual assistant, and/or answer a call) (e.g., as described in FIGS. 6N1-6N2); and in accordance with a determination that the physical press input is a second type of physical press input (e.g., a double press and/or an input that satisfies a second set of input criteria that is different from the first set of input criteria), the computer system causes performance of a second operation that is different from the first operation (e.g., dismiss an action, cancel an action, dismiss an announcement, cancel a request to a virtual assistant, and/or decline an incoming call) (e.g., as described in FIGS. 6O1-6O2). For example, the computer system can cause performance of the first operation in response to detection of physical press input that includes a first type of physical press input or detection of a motion input that includes a first type of recognized head gesture. For example, the first operation that is caused to be performed in response to receiving the indication of the detection of the physical press input is the same operation that is caused to be performed in response to receiving the indication of the detection of the motion input (e.g., in accordance with a determination that the motion input includes the first type of recognized head gesture and the computer system has the first configuration and/or in accordance with a determination that the motion input includes the second type of recognized head gesture and the computer system has the second configuration). In some embodiments, the physical press input includes one or more presses on one earphone of a pair of headphones. In some embodiments, the physical press input includes a squeeze of a portion of a pair of headphones (e.g., a squeeze of a stem of an earbud). In some embodiments, the physical press input includes a press of a button (e.g., a physical button and/or a graphical button), a touch input (e.g., on a touch-sensitive surface), and/or a contact (e.g., on a touch sensitive surface) that is determined to have an intensity that exceeds an intensity threshold. In some embodiments, the first operation and/or the second operation is performed in response to receiving the indication of the physical press input in accordance with a determination that the physical press input is performed before a threshold amount of time has elapsed since an output (e.g., a start of an output or an end of an output) of a notification that can be responded to using a press input or a motion input. Causing performance of the first operation or the second operation in response to a physical press input, based on the type of physical press input, enables the computer system to perform different operations without having to provide multiple options in the user interface, thereby improving feedback to the user, performing an operation when a set of conditions has been met without requiring further user input, and providing additional control options without cluttering the user interface with additional displayed controls.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve notifications and responses to motion inputs. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide suggested responses to notifications that can be responded to using motion inputs. Accordingly, use of such personal information data enables users to have more relevant options. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of notifications and motion inputs, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, options can be selected and delivered to users for selection using motion inputs based on non-personal information data or a bare minimum amount of personal information, such as the content being requested by the device associated with a user, other non-personal information available to the device associated with a user, or publicly available information.

What is claimed is:

1. A computer system configured to communicate with one or more input devices, comprising:
one or more processors; and
memory storing one or more programs configured to be executed by the one or more processors, the one or more programs including instructions for:
receiving, via the one or more input devices, an indication of a detection of a motion input; and
in response to receiving the indication of the detection of the motion input:
in accordance with a determination that the motion input includes a first type of recognized head gesture and the computer system has a first configuration, causing performance of a first operation;
in accordance with a determination that the motion input includes the first type of recognized head gesture and the computer system has a second configuration that is different from the first configuration, forgoing causing performance of the first operation; and
in accordance with a determination that the motion input includes a second type of recognized head gesture that is different from the first type of recognized head gesture and the computer system has the second configuration, causing performance of the first operation.

2. The computer system of claim 1, the one or more programs further including instructions for:
in response to receiving the indication of the detection of the motion input:
in accordance with a determination that the motion input includes the second type of recognized head gesture and the computer system has the first configuration, causing performance of a second operation that is different from the first operation.

3. The computer system of claim 2, wherein the second operation includes responding to a notification by declining to take an action associated with the notification.

4. The computer system of claim 3, wherein the second operation includes causing, without performing another operation, at least a portion of an audio output associated with the notification to not be performed.

5. The computer system of claim 4, wherein causing the portion of the audio output associated with the notification to not be performed includes causing the audio output associated with the notification to stop being performed before the portion of the audio output associated with the notification is output.

6. The computer system of claim 3, wherein the second operation includes:
after declining to take the action associated with the notification, outputting a set of one or more selectable options corresponding to respective operations associated with the notification.

7. The computer system of claim 6, the one or more programs further including instructions for:
after outputting the set of one or more selectable options:
in accordance with a determination that an input corresponding to selection of a first option of the set of one or more selectable options has been detected, causing performance of an operation corresponding to the first option.

8. The computer system of claim 7, the one or more programs further including instructions for:
after outputting the set of one or more selectable options:
in accordance with a determination that a set of one or more criteria associated with the set of one or more selectable options is satisfied, forgoing causing performance of the operation corresponding to the first option.

9. The computer system of claim 1, wherein:
in accordance with a determination that a head gesture configuration setting is in a first configuration state, the computer system is determined to have the first configuration; and
in accordance with a determination that the head gesture configuration setting is in a second configuration state that is different from the first configuration state, the computer system is determined to have the second configuration.

10. The computer system of claim 1, wherein the first type of recognized head gesture includes one or more head movements indicative of a head nod gesture.

11. The computer system of claim 1, wherein the second type of recognized head gesture includes one or more head movements indicative of a head shake gesture.

12. The computer system of claim 1, wherein the detection of the motion input is performed with one or more wearable headphones.

13. The computer system of claim 12, wherein the one or more wearable headphones include a pair of wearable headphones, the one or more programs further including instructions for:
in response to receiving the indication of the detection of the motion input:
in accordance with a determination that a set of one or more error criteria is satisfied, the set of one or more error criteria including a first criterion that is satisfied when the motion input includes a respective type of recognized head gesture and a second criterion that is satisfied when only one of the pair of wearable headphones is being worn, causing output of an indication that an error has occurred.

14. The computer system of claim 1, wherein:
in accordance with a determination that a language setting is in a first language state, the computer system is determined to have the first configuration; and
in accordance with a determination that the language setting is in a second language state that is different from the first language state, the computer system is determined to have the second configuration.

15. The computer system of claim 1 wherein:
in accordance with a determination that a region setting is in a first region state, the computer system is determined to have the first configuration; and
in accordance with a determination that the region setting is in a second region state that is different from the first region state, the computer system is determined to have the second configuration.

16. The computer system of claim 1, wherein the detection of the motion input occurs within a threshold amount of time of a notification.

17. The computer system of claim 16, wherein the notification includes an audio notification.

18. The computer system of claim 1, the one or more programs further including instructions for:
in response to receiving the indication of the detection of the motion input:
prior to causing performance of an operation in accordance with a determination that the motion input includes a respective type of recognized head gesture, causing a first output via one or more output devices.

19. The computer system of claim 18, the one or more programs further including instructions for:
in response to receiving the indication of the detection of the motion input:
after causing the first output and in accordance with a determination that the motion input includes a respective type of recognized head gesture, causing a second output via the one or more output devices.

20. The computer system of claim 1, the one or more programs further including instructions for:
in response to receiving the indication of the detection of the motion input:
prior to causing performance of an operation in accordance with a determination that the motion input includes a respective type of recognized head gesture:
in accordance with a determination that a progress setting is in a first state, causing a first output via one or more output devices; and
in accordance with a determination that the progress setting is in a second state that is different from the first state, forgoing causing the first output via the one or more output devices.

21. The computer system of claim 1, wherein the first operation includes answering a call.

22. The computer system of claim 1, wherein the first operation includes a recommended operation that is presented to a user.

23. The computer system of claim 22, wherein the recommended operation includes creating a reminder.

24. The computer system of claim 22, wherein the recommended operation includes responding to a message.

25. The computer system of claim 24, wherein responding to the message includes generating a response with content that is based on a user input and sending the response.

26. The computer system of claim 24, wherein responding to the message includes sending a predefined response.

27. The computer system of claim 26, wherein sending the predefined response includes sending a response that is a confirmation to the message.

28. The computer system of claim 26, wherein the predefined response includes content that is based on information associated with a user of the computer system and that is available to the computer system.

29. The computer system of claim 1, wherein the first operation includes outputting content of a notification.

30. The computer system of claim 29, the one or more programs further including instructions for:
prior to receiving the indication of the detection of the motion input, audio of a summary of content of a notification is output.

31. The computer system of claim 1, the one or more programs further including instructions for:
prior to receiving the indication of the detection of the motion input, audio of a portion of content of a notification is output.

32. The computer system of claim 1, the one or more programs further including instructions for:
in response to receiving the indication of the detection of the motion input:
in accordance with a determination that a motion input control setting is disabled, forgoing causing performance of an operation based on the motion input.

33. The computer system of claim 1, the one or more programs further including instructions for:
in accordance with a determination that a connection has been established between the computer system and an external computer system, a user interface element for enabling the computer system to perform operations in response to motion inputs is displayed;
an input corresponding to selection of the user interface element for enabling the computer system to perform operations in response to motion inputs is detected; and
in response to detection of the input corresponding to selection of the user interface element for enabling the computer system to perform operations in response to motion inputs, the computer system is enabled to cause performance of operations in response to motion inputs.

34. The computer system of claim 1, wherein:
a tutorial is provided, wherein providing the tutorial includes:
causing display of a user interface that includes instructions for performing the first type of recognized head gesture and the second type of recognized head gesture; and
causing output of audio feedback in response to motion inputs detected while the instructions for performing the first type of recognized head gesture and the second type of recognized head gesture are displayed.

35. The computer system of claim 34, wherein providing the tutorial includes:
causing display of instructions for a user to perform the first type of recognized head gesture; and
after receiving an indication that a motion input that includes the first type of recognized head gesture has been detected, causing output of a prompt to continue the tutorial.

36. The computer system of claim 35, wherein:
causing output of the prompt to continue the tutorial is performed in response to receiving the indication that the motion input that includes the first type of recognized head gesture has been detected;
causing output of the prompt to continue the tutorial includes causing output of an option to provide instructions for the user to perform the second type of recognized head gesture;
an input corresponding to selection of the option to provide instructions for the user to perform the second type of recognized head gesture is detected; and
in response to detection of the input corresponding to selection of the option to provide instructions for the user to perform the second type of recognized head gesture, causing output of instructions for the user to perform the second type of recognized head gesture are output.

37. The computer system of claim 1, the one or more programs further including instructions for:
receiving, via the one or more input devices, an indication of a detection of a physical press input; and
in response to receiving the indication of the detection of the physical press input:
in accordance with a determination that the physical press input is a first type of physical press input, causing performance of the first operation; and
in accordance with a determination that the physical press input is a second type of physical press input, causing performance of a second operation that is different from the first operation.

38. A non-transitory computer-readable storage medium storing one or more programs configured to be executed by one or more processors of a computer system that is in communication with one or more input devices, the one or more programs including instructions for:
receiving, via the one or more input devices, an indication of a detection of a motion input; and
in response to receiving the indication of the detection of the motion input:
in accordance with a determination that the motion input includes a first type of recognized head gesture and the computer system has a first configuration, causing performance of a first operation;
in accordance with a determination that the motion input includes the first type of recognized head gesture and the computer system has a second configuration that is different from the first configuration, forgoing causing performance of the first operation; and
in accordance with a determination that the motion input includes a second type of recognized head gesture that is different from the first type of recognized head gesture and the computer system has the second configuration, causing performance of the first operation.

39. A method, comprising:
at a computer system that is in communication with one or more input devices:
receiving, via the one or more input devices, an indication of a detection of a motion input; and
in response to receiving the indication of the detection of the motion input:
in accordance with a determination that the motion input includes a first type of recognized head gesture and the computer system has a first configuration, causing performance of a first operation;
in accordance with a determination that the motion input includes the first type of recognized head gesture and the computer system has a second configuration that is different from the first configuration, forgoing causing performance of the first operation; and
in accordance with a determination that the motion input includes a second type of recognized head gesture that is different from the first type of recognized head gesture and the computer system has the second configuration, causing performance of the first operation.
